(19) United States
(12) Patent Application Publication
(10) Pub. No.: US 2003/0176516 A1
(43) Pub. Date: Sep. 18, 2003

(54) Cellular perfluoroelastomeric compositions, sealing members, methods of making the same and cellular materials for medical applications

(75) Inventors: Christopher John Underwood, Sale (GB); Francis Joseph Asti, Elkton, MD (US); James W. Hughes, Lansdale, PA (US); Melvin A. Schoenbeck, Wilmington, DE (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Greene, Tweed of Delaware, Inc., Wilmington, DE (US)

(21) Appl. No.: 10/099,213

(22) Filed: Mar. 15, 2002

(51) Int. Cl. C08J 9/00

(52) U.S. Cl. 521/50

(57) ABSTRACT

Closed-cell and/or open-cell cellular perfluoroelastomeric materials are described which may be adapted for use in sealing members and laminates which improve low temperature elastomeric properties of perfluoroelastomeric materials. A variety of unique medical devices based on cellular and solid perfluoroelastomers are also described. The closed-cell cellular perfluoroelastomers are formed by combining a perfluoroelastomeric composition and a curing agent with a plurality of microspheres and/or a gas generating agent at a temperature high enough to soften the perfluoroelastomeric composition, but not high enough to expand the microspheres or activate the gas generating agent and then further heating the composition, microspheres and/or gas generating agents to cure the elastomer, expand the microspheres and/or activate the gas generating agent. Open-cell cellular perfluoroelastomers are formed by combining a perfluoroelastomeric composition, a curing agent and a pore forming agent in solvent, at least partially removing the solvent, curing the perfluoroelastomeric composition and removing the pore forming agent.

### BACKGROUND OF THE INVENTION

This application concerns improved cellular elastomeric materials, particularly perfluoroelastomeric materials and methods in which to improve certain properties of such materials as described further below. Further, the application is directed to adaptation of cellular materials for medical and other uses.

Perfluoroelastomeric materials are known for their high levels of chemical resistance, plasma resistance, acceptable compression set resistance and satisfactory mechanical properties. As such, they have many desirable applications, including use as elastomeric seals in applications where the seal or gasket will be subject to corrosive chemicals or extreme operating conditions, for use as molded parts which are capable of withstanding deformation, for the semiconductor industry due to their plasma resistance, and for many other applications. Such materials are typically formed using perfluorinated monomers, including a perfluorinated curesite monomer, polymerizing the monomers and curing (cross-linking) the composition using a curing agent which reacts with the incorporated curesite monomer thus forming a material which exhibits typical elastomeric characteristics. Perfluoroelastomers, while having many advantages have various drawbacks as outlined below.

Due to the high cost of perfluorinated components, the cost of such seals and gaskets or other materials and articles formed using perfluoroelastomers is typically very much higher than the costs associated with other elastomeric materials. As such, while the properties of perfluoroelastomers are highly desirable, their uses tend to be limited, so it would also be desirable to reduce the amount of raw material required for forming perfluoroelastomeric articles while still maintaining or improving the desirable characteristics of the resulting article.

While perfluoroelastomers generally exhibit good high temperature properties and can be used in low temperature applications to approximately −20° C., perfluoroelastomers currently available are not generally acceptable for use at temperatures lower than about −20° C. There is a need in the art to improve the range of performance temperatures using perfluoroelastomeric materials.

Compression set refers to the propensity of an elastomeric material to remain distorted and not return to its original shape after a deforming compressive load has been removed. The compression set value is expressed as a percentage of the original deflection that the material fails to recover. For example, a compression set value of 0% indicates that a material completely returns to its original shape after removal of a deforming compressive load. Conversely, a compression set value of 100% indicates that a material does not recover at all from an applied deforming compressive load. A compression set value of 30% signifies that 70% of the original deflection has been recovered. Higher compression set values generally correspond to a potential for seal leakage.

Elastomers of various types as well as fluorinated thermoplastics such as polytetrafluoroethylene (PTFE) have been adapted for many uses and applications, particularly for use in human and animal bodies for medical purposes, such as for implants, grafts and insertable medical devices. Typical prior art elastomers or plastics used in such medical applications include polyurethanes, PTFE, expanded PTFE and silicones among others. The drawbacks of such prior art materials include, for example, that silicones, while having many acceptable properties generally do not demonstrate sufficient strength and related mechanical properties in the body, for example, exhibit poor tear strength and suture pull-out resistance. Polyurethanes, while having excellent physical properties for some applications, can exhibit degradation, typically hydrolytic degradation, that can lead to catastrophic failure of critical medical devices. Expanded PTFE, while conformable and having excellent biocompatibility, is not sufficiently distensible and has cloth-like properties which, while acceptable for some applications such as hernia repair or a pericardial patch, are not ideal for many other applications requiring distensibility and elastomeric properties, for example, for use in blood vessels. Therefore, current materials remain compromises and all have shortcomings. Accordingly, there is a need in the art for a material having a combination of advantageous properties for use in advanced devices.

The desirable combination of advantageous properties for medical implants, grafts and other devices includes a material which is biocompatible, flexible, kink-resistant, capable of being formed into sizes approximating those of natural tissues or organs which need replacement, of a high degree and preferably of an absolute level of chemical resistance, non-toxic, non-degradable in the body and/or physically robust. For implants and grafts, the material should also have mechanical properties that are substantially similar or identical to the properties of the body part being replaced or into which the part is being inserted, and should be capable of being formed into the desired size, shape and geometry of the part being replaced and/or to be conformable to the area into which the part is being inserted. For example, with respect to vascular prostheses, it would be desirable to develop a prosthesis that matches the properties of a blood vessel in order to achieve the functional capacity of the vessel. Important properties for such prostheses include dimensions which are similar or identical to the appropriate size and geometry of a vessel, elastomeric properties, biocompatibility, non-degradability (physical or chemical), and sufficient strength and mechanical properties which emulate those of a blood vessel. It would also be desirable to have a material that permits tissue adhesion and ingrowth.

It is known in the art to form various cellular and/or expanded polymeric materials. Cellular or foamed polymers including elastomers such as polyurethanes and the like are well known. Open or closed celled materials may be made using a variety of foaming methods, including use of a wide variety of blowing agents or volatilizable compounds. It is also known to form controlled porosity polyurethanes, poly(ether)urethanes and polyurethane urea compounds by combining such materials in solution with a pore-forming agent such as a sodium hydrogen carbonate and a surfactant, and coagulating the polyurethane. The pore forming material is then dissolved using water to leave behind a porous solid polymer structure after drying. These materials are adapted for use in medical applications such as for arteries. Such materials and methods are described, for example, in WO 90/05628, WO 92/09652 and U.S. Pat. Nos. 5,132,066 and 5,549,860.

In addition, it is known to expand polymers, including perfluoropolymers (such as PTFE) using mechanical means or using microspheres in order to provide insulating sheaths around conductive cores or for use in seals and gaskets. Expanded polymers are formed by combining such materials in slurry or dispersion form with expandable microspheres thereby forming a closed-cell expanded structure. Such methods and expanded materials are described in U.S. Pat. Nos. 5,750,931, 5,754,931, 5,429,869 and 5,738,936.

However, successful commercial adaptation of known methods of expanding natural or other synthetic rubbers or of expanding perfluoroplastics has not been previously thought to be desirable for use with perfluoroelastomers or in forming articles made from such materials, such as O-rings and the like. One reason why such attempts have not been demonstrated is the belief that providing a cellular structure to a perfluoroelastomer would have a significant, negative impact to the compression set value of the perfluoroelastomer. A further reason is that perfluoroelastomers, due to their high levels of chemical resistance, are consequently insoluble in most solvents. The methods which may be used to expand perfluoroplastics or other elastomers have not been used for perfluoroelastomers in forming expanded perfluoroelastomers which retain the desirable properties of solid perfluoroelastomers.

Accordingly, there is a need in the art for a method for forming perfluoroelastomeric compositions which requires less perfluoroelastomeric material to reduce the overall cost of such materials in order to use their excellent properties in new applications, with minimal effect on favorable characteristics and properties of the perfluoroelastomers used in such compositions. It would also be desirable to develop a perfluoroelastomeric material that is useful in low temperature applications, well below −20° C., while retaining flexibility and sealing properties.

There is further a need in the art for a method for forming cellular perfluoroelastomeric materials in order to make the beneficial properties of such new materials, such as a reduced apparent hardness, available for new applications and uses such as medical implantations, devices, prostheses, grafts and components for which reduced apparent hardness, good needle penetrability and/or resealing ability are desired along with the above-noted preferred combination of properties. Further, such materials should desirably have improved tear resistance and provide an inert, biocompatible structure that may permit tissue ingrowth and serve as a scaffold for growth as natural tissue. There is also a need in the art for suitable materials for use in forming medical implantations, devices, prostheses, grafts and components.

### BRIEF SUMMARY OF THE INVENTION

The invention includes a closed-cell cellular perfluoroelastomeric composition, comprising a perfluoroelastomeric composition, comprising a curable perfluoropolymer; and at least one material selected from the group consisting of a plurality of microspheres and a gas-generating agent.

In one embodiment, the invention includes an article formed by a method comprising applying heat to a perfluoroelastomeric composition, comprising a curable perfluoropolymer and at least one material selected from the group consisting of a plurality of microspheres and a gas-generating agent to perform at least one of expanding the microspheres and activating the gas-generating agents.

The invention also includes a closed-cell cellular perfluoroelastomer, comprising a perfluoroelastomeric matrix; and a plurality of closed cells formed in the perfluoroelastomeric matrix, wherein the closed cells are formed from a material selected from the group consisting of a plurality of microspheres and a gas-generating agent.

Also included in the invention is an open-cell cellular perfluoroelastomer, comprising a perfluoroelastomeric matrix having a plurality of open pores.

The invention further includes a method for making a closed-cell, cellular perfluoroelastomer, comprising (a) combining a perfluoroelastomeric composition with at least one material selected from the group consisting of a plurality of microspheres and a gas-generating agent at a temperature high enough to soften the perfluoroelastomeric composition but not high enough to expand the microspheres and/or activate the gas-generating agent; and (b) further heating the perfluoroelastomeric composition and the at least one material from step (a) to cure the perfluoroelastomeric composition and to expand the microspheres and/or activate the gas-generating agent, thereby forming a cellular perfluoroelastomer having a plurality of closed cells.

A further method is included in the invention for making an open-cell cellular perfluoroelastomer. The method comprises: (a) combining (i) a perfluoroelastomeric composition, comprising at least one curable perfluoropolymer and (ii) at least one of a pore forming agent and a gas-generating agent in a solvent capable of dissolving the curable perfluoropolymer but incapable of dissolving the pore forming agent or gas-generating agent to form a solution; (b) at least partially removing the solvent from the solution to form a matrix; (c) curing the at least one curable perfluoropolymer and removing the pore forming material from the matrix thereby forming a cellular perfluoroelastomer having a plurality of open cells.

Additionally the invention includes a method for improving low temperature elastomeric properties of a perfluoroelastomeric sealing member, comprising forming a sealing member which comprises a cellular perfluoroelastomeric material.

The invention further includes a device for use in a body which comprises a perfluoroelastomeric material. In one embodiment the invention includes a device for use in a body which comprises a cellular perfluoroelastomeric material.

The invention also includes a closed-cell cellular fluoroelastomeric composition, comprising a fluoroelastomer composition, comprising a fluoroelastomer derived from a curable fluoropolymer in liquid or paste form; and at least one material selected from the group consisting of a plurality of microspheres and a gas-generating agent.

An open-cell cellular fluoroelastomeric composition, comprising a fluoroelastomeric matrix having a plurality of open pores is also encompassed within the embodiments of the invention, wherein the fluoroelastomeric matrix is derived from a curable fluoropolymer in liquid or paste form.

The invention additionally includes a method for making an open-cell cellular fluoroelastomeric composition, comprising mixing a pore forming agent with a curable fluoroelastomer composition in liquid or paste form, curing the fluoroelastomer and removing the pore forming agent.

A method for making an open-cell, cellular perfluoroelastomer is further provided which comprises (a) combining (i) a perfluoroelastomeric composition in a solvent latex form, comprising at least one curable perfluoropolymer and (ii) at least one of a pore forming agent and a gas-generating agent; (b) at least partially removing the solvent in the solvent latex from the perfluoroelastomeric composition to form a matrix; and (c) curing the at least one curable perfluoropolymer and removing the pore forming material from the matrix thereby forming a cellular perfluoroelastomer having a plurality of open cells.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings, the same reference numerals are employed for designating the same elements throughout the several figures. In the drawings:

FIG. 1 is a cross-sectional view of a closed-cell cellular perfluoroelastomer sealing member formed in accordance with one embodiment of the invention;

FIG. 2 is a cross-sectional view of an open-cell cellular perfluoroelastomer sealing member in accordance with a further embodiment of the invention;

FIG. 3 is a cross-sectional view of a perfluoroelastomer sealing member formed in accordance with the invention having both open and closed cells;

FIG. 4 is a perspective view of a tubular vascular graft formed using a cellular material according to the invention;

FIG. 4A is a cross sectional view of the tubular vascular graft of FIG. 4 taken along line 4A-4A;

FIG. 5 is a greatly enlarged view of a portion of the tubular vascular graft of FIG. 4;

FIG. 6 is a side elevational view of a synthetic lattice formed using a cellular material in accordance with the invention;

FIG. 7 is a greatly enlarged view of a portion of the lattice of FIG. 6;

FIG. 8 is a graphical representation of the storage modulus of the sample materials of Example 6 herein over temperatures from ambient to −60° C.;

FIG. 9 is a graphical representation of the relationship of stress (MPa) to % extension in tensile strength testing of vascular prosthesis tubular Samples in Example 7;

FIG. 10 is a graphical representation of the relationship of stress (MPa) to % radial extension for hoop stress testing of vascular prosthesis tubular Samples in Example 7;

FIG. 11 is a graphical representation of the relationship of stress (MPa) to % compression for compression testing of vascular prosthesis tubular Samples in Example 7;

FIG. 12 is a graphical representation of the relationship of stress (MPa) to % extension for tensile strength of sheet Samples in Example 7; and

FIG. 13 is a scanning electron micrograph of a Sample formed in Example 9.

### DETAILED DESCRIPTION OF THE INVENTION

The present invention is directed to forming cellular perfluoroelastomeric materials and compositions, including both open-cell and closed-cell perfluoroelastomers, methods of making such cellular materials and applications of such materials both as internal cores and outer sheaths for sealing members such as O-rings and the like or as stand alone items, for example, for use in making medical implants, cardiovascular prostheses and tissue engineered products utilizing synthetic lattices. Such lattice materials act as a scaffold for the growth of human or animal cells within the scaffold. The compositions of the present invention and cellular perfluoroelastomers also provide for significant advantages in that they are capable of performing in sealing applications while maintaining adequate elastomeric properties at low temperatures below −20° C. which include temperatures as low as −40° C. and to −60° C.

As used herein, “perfluoroelastomer” may be any cured elastomeric material, derived by curing a perfluoroelastomeric composition (as defined herein) which includes a curable perfluoropolymer having a crosslinking group to permit cure. A perfluoroelastomer is substantially completely fluorinated, and preferably completely fluorinated with respect to the carbon atoms on the backbone of the perfluoropolymer. It will be understood, based on this disclosure, that some residual hydrogen may be present in perfluoroelastomers within the crosslinks due to use of hydrogen in the functional crosslinking group in some perfluoroelastomeric compositions. Perfluoroelastomers are generally cross-linked polymeric structures. The perfluoropolymers, used in perfluoroelastomeric compositions to form perfluoroelastomers upon cure, are formed by polymerizing one or more perfluorinated monomers, one of which is preferably a perfluorinated curesite monomer having a functional group to permit curing. One or more perfluoropolymers, and preferably at least one curing agent, are combined in a perfluoroelastomeric composition which is then cured forming the resulting crosslinked elastomer, or perfluoroelastomer.

As used herein, a “perfluoroelastomeric composition” is a polymeric composition including a curable perfluoropolymer formed by polymerizing two or more perfluorinated monomers, including at least one perfluorinated monomer which has at least one functional group to permit curing, i.e. at least one curesite monomer. Such materials are also referred to generally as FFKMs in accordance with the American Standardized Testing Methods (ASTM) definition and as described further herein.

As used herein, a “perfluoroelastomeric matrix,” unless otherwise specifically designated as cured or uncured, refers to the surrounding matrix of the cellular materials described herein regardless of whether the matrix is in its uncured or cured state, and is used herein to refer to the physical matrix surrounding the poreforming agents and/or resulting cells. As such, it may include a perfluoroelastomeric composition and all of its components and/or additives.

Also, the use of the term “cellular” herein is intended to mean open-cell or closed-cell cellular materials unless otherwise specified to be only open-cell or only closed-cell.

A “sealing member” may be any elastomeric member intended for placement between two articles which are to be joined that acts to seal or otherwise fill space or gaps existing between the two articles such as flanges and the like. Examples of sealing members include O-rings, gaskets, V-rings, U-cups, valve seats, tubing, “down hole” packing elements, or other sealing parts, including those of custom design. One of ordinary skill in the art would understand that the seal may be formed in any desired shape.

A “sheath” as that term is used herein is intended to mean an outer coating which completely surrounds an elastomeric composition or matrix, and is not intended to be limited to a tubular configuration.

As used herein, with respect to medical applications, “device” is intended to have its broadest meaning including, without limitation, all types of medical devices, parts, components, vascular protheses, grafts, implants, tissue engineered products such as those using synthetic lattices for use in forming a scaffold, synthetic spinal disks, breast prostheses and any other device which can act to replace soft tissue, tubes, catheters, stents, drainage tubes, pericardial patches, cannulae, fistulas, ports, and the like.

With the foregoing definitions in mind, the preferred embodiments of the cellular perfluoroelastomers, methods of making such perfluoroelastomers and other related embodiments will now be described. Following such description will be a description of the application of such materials in medical applications.

A closed-cell cellular perfluoroelastomeric composition according to the invention includes a perfluoroelastomeric composition and a plurality of microspheres. The perfluoroelastomer composition may include any suitable curable perfluoroelastomeric perfluoropolymer(s) (FFKM) capable of being cured to form a perfluoroelastomer, and preferably one or more curing agents. Other additives, co-agents, processing aids, fillers and the like may also be suitably included within a perfluoroelastomeric composition as described further hereinbelow. Such perfluoroelastomeric compositions preferably include one or more of various perfluorinated copolymers of at least one fluorine-containing ethylenically unsaturated monomer, such as tetrafluoroethylene (TFE), hexafluoropropylene (HFP), and perfluoroalkylvinyl ethers (PAVEs) which include alkyl groups that are straight, branched and include ether linkages, such as perfluoro(methyl vinyl ether), perfluoro(ethyl vinyl ether), perfluoro(propyl vinyl ether), perfluoroalkoxyvinyl ethers and other similar compounds. Preferred perfluoropolymers are terpolymers of TFE, PAVE, and at least one perfluorinated cure site monomer which incorporates a functional group to permit crosslinking of the terpolymer. Suitable curesite monomers include those having cyano curesites, bromo, iodo or pentafluorophenoxy functional groups, among others. Such monomers are well known in the art. Curing agents for use with various perfluoroelastomer compositions including bisphenols and their derivatives, tetraphenyltin and peroxide-based curing systems. In addition, the perfluoropolymers may be cured using radiation curing technology. Such materials are all well known in the art.

Many such cured perfluoroelastomers are commercially available. Preferred perfluoroelastomers are used in Chemraz® parts, which are commercially available from Greene, Tweed & Co., Inc. of Kulpsville, Pa. Other preferred perfluoroelastomers include perfluoroelastomeric cured Kalrez® parts and materials, which are commercially available from E. I. du Pont de Nemours of Wilmington, Del. Uncured commercial perfluoropolymers are also known, including Simiriz®, which is available from Freudenberg of Germany, Dyneon®, available from Minnesota Mining & Manufacturing in Minnesota, Daiel-Perfluor®, which is available from Daikin Industries, Ltd. of Osaka, Japan. Similar materials are available also from Ausimont S.p.A. in Italy.

Microspheres useful in the present invention are generally those which have a polymeric outer coating and an expandable liquid or gaseous fluid within the outer coating. Such polymeric outer coatings are generally thermoplastic in nature and the microspheres adapted to expand significantly when exposed to energy such as heat energy. The microspheres are monocellular particles which have a body of polymeric material surrounding the fluid so that when heated or exposed to a similar form of energy, the polymer will soften and the fluid material will expand. As a result, the entire microsphere will increase in size substantially. Once cooled, however, the polymeric material in the outer coating of the microsphere will cease to flow and tends to retain its enlarged shape.

Suitable and preferred microspheres are commercially available from Akzo Nobel through Expancel, Inc. in Duluth, Ga. under the product name Expancel® in a variety of sizes and shapes. The initial expansion temperatures typically range from about 80° C. to about 135° C. or higher. Expansion can be effected at temperatures ranging from about 80° C. to about 260° C. or higher depending upon a number of factors, including the specified microsphere, the dwell time, and the desired curing temperature of the uncured perfluoroelastomeric matrix. Weight average-based diameters of such Expancel® microspheres prior to expansion range from about 6 to about 17 microns and have an average expanded diameter of from about 20 to about 120 microns. The specific gravity of the unexpanded microspheres is from about 1.05 to about 1.2, but after expansion, can be as low as 0.02 indicating a volume increase of about 50 times.

The heat resistance of such microspheres depends upon the specific microsphere and various grades of Expancel® are available for different thermomechanical behavior. As such, the type of Expancel® or other microsphere used will depend on the specific properties desired. The preferred microsphere for use in the present invention is Expancel® DU, grade 091, as well as grades 091-80, 091-130 and 092-120.

It should be understood, based on this disclosure, that expandable microspheres, while preferably Expancel® microspheres, may be any hollow resilient container filled with expandable fluid which is capable of significant volumetric expansion. Further, the shape of such microspheres may be varied, and need not be spherical, but can have any shape such as ellipsoid, cubic and the like, provided that they are capable of significantly expanding in size in order to depart a closed-cell structure within the perfluoroelastomeric matrix. While the shapes and sizes may be varied as may be the outer coating and the expandible fluid, it is preferred that microspheres having a particle size of from about 3 to about 50 microns are used which have an outer shell formed of an acrylic-based, and preferably an acrylonitrile-based copolymer enclosing a hydrocarbon blowing agent as the volatile fluid, such as isopentane and the like.

The closed-cell cellular perfluoroelastomeric composition of the present invention may include any amount of microspheres sufficient to provide the desired characteristics of the cellular material. Based on 100 parts by weight of perfluoropolymer(s) used in the perfluoroelastomeric composition, preferably microspheres are included in the closed-cell cellular compositions of the invention at from very low concentrations of about 0.1 parts to about 30 parts, more preferably from about 0.1 to about 12 parts of the microspheres, and most preferably from about 0.1 to about 8 parts of the microspheres are used, depending upon the desired properties of the cellular materials. The microspheres should preferably be added in amounts not exceeding 30 parts if elastomeric properties are critical as amounts exceeding 30 parts may contribute to a reduction in elastomeric properties. However, if other properties or a high degree of porosity are desired, such amounts may be modified. In a preferred embodiment, the microspheres are present in an amount of from about 4 to about 8 percent by weight of the entire composition including any additives as described below.

In forming a closed-cell cellular perfluoroelastomeric composition, in addition to microspheres as described above, the composition may further include a gas-generating agent. Such materials are preferably chemical foaming or blowing agents which are preferably capable of activation using heat and which preferably decompose at temperatures approaching, at or above the curing temperature of the perfluoroelastomeric composition, preferably at about the curing temperature. Optional activation agents may alternatively be used or may be used in conjunction with heat activation to accelerate the activation. Effective gas-generating agents are preferably aromatic compounds, more preferably aromatic azides such as hydrazides or carbazides having reactive amine and/or sulfonyl groups which, under operating temperatures of about 200° F. to about 375° F. are capable of generating gases, prior to or during curing, which would not significantly affect the matrix. Preferably, such gas-generating agents generate nitrogen gas. Preferred compounds include, but are not limited to p,p′-oxybis(benzenesulfonyl hydrazide), p-toluene sulfonyl hydrazide and similar aromatic hydrazides. Such materials are commercially available from Uniroyal Chemical Company under the name Celogen. Especially preferred are Celogen® OT, Celogen® AZ and Celogen® TSH. The materials are typically in the form of a white to cream colored powder of very fine particle size, preferably of about 2 to about 20 microns. The activation agent may be heat or a chemical agent including any material compatible with the perfluoroelastomeric composition and matrix. Preferably the activation agent is heat, which may be direct or indirect (such as microwave heating). It will be understood based on this disclosure that varied techniques may be undertaken for activating and using such gas-generating agents for forming closed-cell and/or open-cell cellular materials as described further herein.

The gas-generating agent may be provided to the perfluoroelastomeric composition by standard mixing or milling techniques for such perfluoroelastomeric composition materials, such as roll mixing or by Banbury mixer preferably at temperatures low enough to not activate the material. Once in the matrix, the degree of expansion may be controlled by limiting the expansion volume in the mold and/or the blowing or foaming agent used. If the amount of expansion is limited, the cells in the matrix will be formed as closed cells, i.e., the cells are not fully expanded to rupture by the gas generated and remain closed in structure. However, substantial or complete activation can also be affected and the mold expansion not so limited, providing sufficient volume for substantial or complete expansion of the cells such that a portion, substantially all or all of the cells are opened within the perfluoroelastomeric matrix. Therefore the present invention encompasses a cellular perfluoroelastomer which includes closed cells, a combination of open and closed cells or open cells which differing materials can be achieved through various combinations of use of the gas-generating agent, with or without microspheres, used with or without the pore forming technique described below. Such wide variety of cellular perfluoroelastomeric materials provides a range of possible applications from very open celled matrices such as for scaffold materials for tissue engineering applications, closed cell matrices or combination matrices for sealing members for a wide range of medical devices and many others uses.

The gas generating compound may be added to the perfluoroelastomeric composition in amounts, based on 100 parts by weight of the perfluoropolymer(s) in the perfluoroelastomeric composition of about 0.1 parts to about 20 parts, preferably in amounts of about 0.1 to 10 parts, although it will be understood by one of ordinary skill in the art that the amount of gas-generating agent may be varied within and outside of such ranges for achieving different effects within the resulting cellular material.

As noted above, the perfluoroelastomeric composition may also include other materials suitable for addition to perfluoroelastomeric compounds. These include fillers such as graphite, carbon black, clay, silicon dioxide, polymeric graphite, fluoropolymeric particulates (for example, TFE homopolymer and copolymer micropowders), barium sulfate, silica, titanium dioxide, acid acceptors, cure accelerators, glass fibers, or polyaramid fibers such as Kevlar®, curatives and/or plasticizers or other additives known or to be developed in the perfluoroelastomeric art. An example of a plasticizer useful in the present perfluoroelastomeric composition is a perfluorinated alkyl ether, such as Krytox®, which is commercially available from du Pont, Demnum®, which is commercially available from Daikin and Fomblin® which is commercially available from Ausimont in Italy, most preferred being Demnum S-100. Preferably additives are present in the composition in an amount no greater than about 25 percent by weight based on the weight of the perfluoropolymer in the perfluoroelastomeric composition.

The closed-cell cellular perfluoroelastomeric composition is preferably formed by using techniques useful in the method of making a closed-cell cellular perfluoroelastomer as described herein. In such a method, a perfluoroelastomeric composition, for example, including one or more perfluoropolymers formed from one or more suitable perfluorinated monomers and cure site monomer(s) as described above, are preferably combined with a curing agent(s) and a plurality of microspheres and/or gas-generating agents (which as noted above may be controlled through processing to create fully closed, partially closed or open cells within a perfluoroelastomeric matrix). Such materials are combined by mixing, blending or otherwise combining the perfluoroelastomeric composition including the curing agent(s) with the microspheres and/or gas-generating agents in amounts such as those noted above. The materials may be combined, for example, by using a mixer such as those commercially available from Banbury. Other suitable mixers are available from C. W. Brabender instruments, Inc. of S. Hackensack, N.J. and from Morijama of Farmingdale, N.Y. When combining these materials initially, it is important that the temperature be sufficiently high to soften the perfluoroelastomeric composition for blending, but not so high that it will expand the microspheres and/or activate the gas-generating agents prematurely before the microspheres and/or gas-generating agents have been sufficiently dispersed throughout the composition. For the preferred perfluoroelastomeric compositions, the preferred temperatures for combining the components ranges from about 120° F. (49° C.) to about 150° F. (66° C.) and, more preferably from about 130° F. (54° C.) to about 140° F. (60° C.).

The ingredients should preferably be combined such that the microspheres and/or gas generating agents are added last and the combined composition monitored to avoid causing premature expansion of the microspheres and/or activation of the gas-generating agents during the initial combining step. In addition, high shear mixing is preferably not used to ensure the microspheres are well dispersed within the perfluoroelastomeric composition. The shear should be high enough so as to disperse the microspheres, but not so high as to crush them, and to properly disperse the gas-generating agents. A preferred method for combining includes mixing the components on a two-roll rubber mill by feeding the materials in the space between the rolls for a time sufficient to combine, with time on the mill being kept to a minimum. Once the components are properly combined, the microspheres are expanded and/or gas-generating agents activated in a controlled manner so as to create the desired cellular structure, and the composition is cured. While the order of such steps may be altered, it is preferred that expansion of the microspheres and/or activation of the gas-generating agents and the curing occurs substantially simultaneously, however, variation of the order of the steps of the method is within the scope of the invention.

The curing temperature of the perfluoroelastomeric composition will vary depending upon the type of composition used as well as the curing system. Typically such perfluoroelastomeric compositions cure at temperatures ranging from about 280° F. (138° C.) to about 350° F. (177° C.), more preferably 300° F. (149° C.) to 350° F. (177° C.). On of ordinary skill in the art will understand that curing conditions vary with elastomer systems and that such temperature ranges are not intended to be limiting with respect to the scope of the invention, since any perfluoroelastomeric material may be used.

In addition, the temperature needed for expanding the microspheres will also depend on the type and grade of microspheres and/or gas-generating agents employed. For various grades of Expancel® DU, for example, expansion can begin at from about 118° C. to about 126° C., and can be taken to a maximum expansion temperature of from about 160° C. to about 195° C. In the present invention, the preferred expansion temperature must be selected with the perfluoroelastomeric curing temperature also in mind, however, since most perfluoroelastomeric compositions cure at temperatures ranging from about 280° F. (138° C.) to about 350° F. (177° C.), the temperatures can be selected and optimized for the best curing and expansion depending upon the specified microspheres and/or gas-generating agents selected and the particular perfluoroelastomeric composition as well as the designated curing system.

Heating of the combined materials may be undertaken using a variety of heat sources such as heat produced from an exothermic reaction or other heat exchange system, heated molds, a curing oven, radiative energy and the like. Preferably, the term “heating” as used herein includes any application of heat, radiative energy or any other form of energy capable of curing the perfluoroelastomeric composition and expanding the microspheres and/or activating the gas-generating agents.

Once such energy is applied, the elastomeric composition should be allowed to fully cure and the microspheres to fully expand and/or the gas-generating agents to activate to the extent desired in order to provide a cellular perfluoroelastomer having a plurality of closed cells in the form of expanded microspheres and partially or not fully activated gas-generating agents within a perfluoroelastomeric matrix. Such conditions are somewhat determined by the mold size which limits expansion and how much of the composition is provided to the mold. Typically, the more that is provided to the mold, the less expansion and the less the amount of cells generated.

The heating/cooling process can also be affected by using a heat molding process to form an article. The mixture of components may be fed into the chamber or similar opening in any suitable heat molding apparatus, such as an injection mold, compression mold, transfer mold and the like, and the heat from the process can be used to simultaneously or sequentially expand the microspheres and/or activate the gas-generating agents present, cure the perfluoroelastomeric composition, and form a molded cellular elastomeric article. In one preferred embodiment, the composition can be formed as a sealing member, such as any of the sealing members noted above, and most preferably into an O-ring or gasketing member. The sealing member may be formed by placing the composition after mixing in a heat molding apparatus such as an injection mold and expanding and curing the composition within the mold. If this technique is used, the mold should be filled only partially to allow room for expansion of the cured elastomer within the mold. The amount of expansion room will depend upon the targeted reduction in density and to some extent on the perfluoroelastomeric composition used as well as the type and amount of microspheres and/or gas-generating agents. Such parameters can be optimized by calculation of expansion and trial runs using the composition selected in a manner that will be understood to one skilled in the art based on this disclosure.

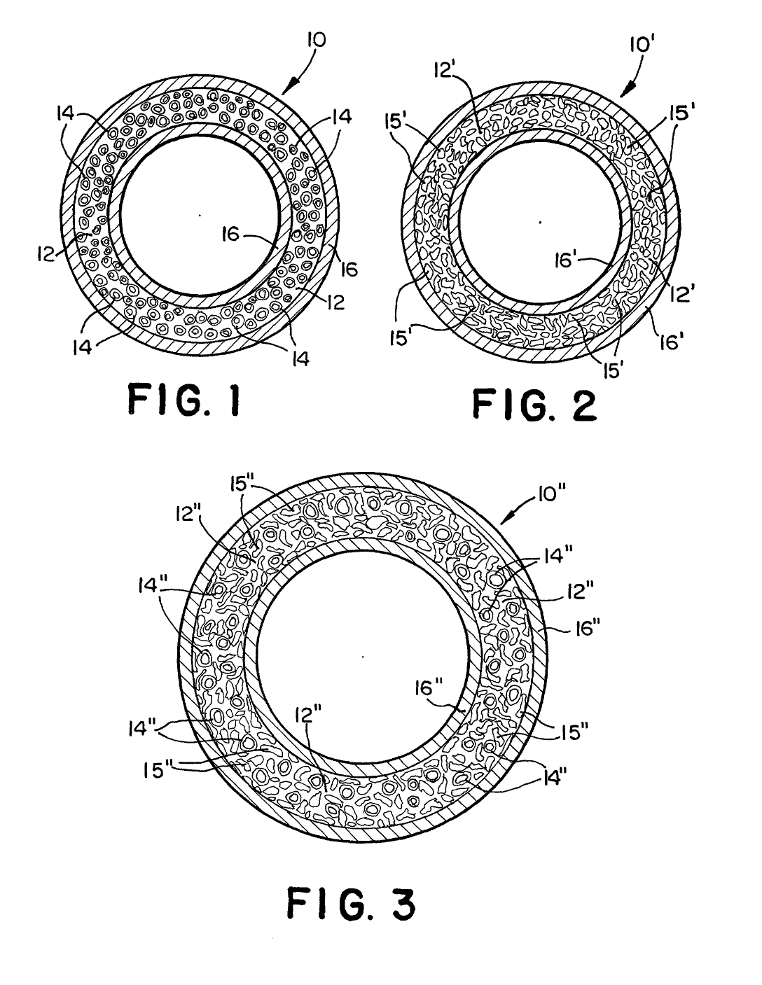

An example of a closed-cell cellular perfluoroelastomeric sealing member is shown in FIG. 1, and is referred to generally herein as sealing member 10. FIG. 1 is intended to be representational only to illustrate the cells within the matrix and should not be interpreted as drawn to scale. The sealing member 10 includes a perfluoroelastomeric matrix 12 and a plurality of closed cells 14 throughout the matrix. An optional outer coating 16 as shown in FIG. 1, while not necessary due to the integrity of the closed cells within the matrix, may be provided for reducing permeability or to vary mechanical properties. Such an outer coating would preferably be formed of a solid perfluoroelastomer, but could also be formed by a further layer of a cellular perfluoroelastomer according to the invention. Suitable solid perfluoroelastomers for forming an outer coating include any of those mentioned above for use in forming the closed-cell perfluoroelastomeric composition, and preferably a Chemraz® or Daiel Perfluor® material or any perfluoroelastomer having similar chemically resistant properties.

By providing such closed cells to the perfluoroelastomeric matrix, structural integrity can be achieved, with a much lighter weight material. By decreasing the amount of perfluoroelastomeric composition required for forming such a sealing member or other article, the cost of the article may be significantly decreased due to the high cost of raw perfluorinated materials. In some applications, the cost of manufacture is minimized while the ability to withstand plasma and corrosive materials may be retained by the solid perfluoroelastomeric sheath on the closed-cell cellular perfluoroelastomer.

In addition to closed-cell cellular perfluoroelastomeric compositions and closed-cell cellular perfluoroelastomers of the invention and the above-described method for making such closed-cell cellular perfluoroelastomers, the present invention also includes open-cell cellular perfluoroelastomeric compositions, open-cell cellular perfluoroelastomers and a method for making such open-cell cellular perfluoroelastomers as well as cellular perfluoroelastomers having both open and closed cells within a perfluoroelastomeric matrix.

The invention includes an open-cell cellular perfluoroelastomer that includes a perfluoroelastomeric matrix and a plurality of open and/or interconnecting pores. Depending upon the application for such a perfluoroelastomeric material, an outer and/or protective coating formed of a solid perfluoroelastomer may be provided to prevent leakage through the open pores. Also an outer coating may be formed from a closed-cell cellular perfluoroelastomer made in accordance with the invention. Such coatings can be provided to the outer surface of any article formed from the open-cell cellular perfluoroelastomer of the invention. It will be understood, based on this disclosure, that while preferred embodiments are described herein and certain uses suggested such as sealing members, that the open-cell cellular perfluoroelastomers of the invention are useful for a wide variety of applications whether used alone as a strictly open-cell material, with a matrix that incorporates both open and closed cells or in a sheathed open cell configuration, including in a chemically inert matrix for other applications, filtration, a low-density interior core for a molded article or laminate and other similar uses.

The open-cell cellular perfluoroelastomer of the invention may have a perfluoroelastomeric matrix formed of any of the perfluoroelastomers described above with respect to the closed-cell cellular perfluoroelastomers, including the preferred materials noted above such as those used to make Chemraz®, from Perfluor® or a similar perfluoroelastomer as noted above. The pores within the matrix have an average pore size which results from the average size of the pore forming agent, as measured in the longest dimension across a pore (or across the pore forming agent) of from about 1 to about 150 microns, and more preferably from about 20 to about 50 microns. Such pores are formed in accordance with the method of the invention as discussed below in order to provide an open-cell cellular perfluoroelastomer which preferably has a narrow (substantially uniform) pore size distribution and in which the pore size can be varied by varying the particle size of the pore forming agent used as described further below. For example, narrow distributions of greater than 0 to about 10 microns or from 10 to 20 microns may be used. However, it should be understood that the method may be varied provided the resulting open-cell cellular perfluoroelastomer includes a perfluoroelastomeric matrix and a plurality of open cells as described herein.

Reduction of the amount of perfluoroelastomer in articles formed from the open-cell cellular material provides a significant advantage in lowering cost with respect to the high expense of forming perfluoroelastomeric materials, but provide a new opportunity to use such open-cell materials for a wide variety of applications, including medical devices, such as, for example, vascular prostheses and scaffold materials for tissue engineering applications, packing, filtration, components for chemically inert sealing members, and laminates among other uses. An example of a sealing member 10′ formed using an open-cell cellular perfluoroelastomer formed in accordance with the present invention is shown in FIG. 2 in a representative manner. FIG. 2 is not intended to be drawn to scale but is provided generally for illustration. In FIG. 2, a perfluoroelastomeric matrix 12′ is shown having a plurality of open pores 15′ which are highly uniform in size. An optional outer protective coating 16′ may be provided. The optional outer coating, or sheath as shown may be formed of a solid perfluoroelastomer for providing chemical resistance and preventing leakage of the sealing member for applications requiring a tight seal. Alternatively, for lighter weight or lower density materials, a closed-cell perfluoroelastomeric sheath or outer coating may be provided. Such a closed-cell cellular material may be formed in the manner described above. In addition, if a tight seal is not required, the open-cell perfluoroelastomer of the invention may be coated with another, different open-cell cellular material or any other suitable coating depending on the application or intended use of the article.

The closed-cell cellular perfluoroelastomers provide good chemical resistant properties, reduced cost and the ability to retain a hardness of generally below 60 durometer when formed into sealing members, as well as acceptable compression set levels of approximately 24% at temperatures up to 150° F. (65.5° C.). Similar characteristics are also achieved using an open-cell cellular perfluoroelastomer in a sealing member in that good chemical resistance is retained when providing a perfluoroelastomeric outer coating to the open-cell material. The material affords a method for forming a softer and less expensive sealing member. Further, the raw material cost of forming the sealing members is reduced. In addition, open-cells within a perfluoroelastomeric matrix within a sealing member can assist in providing good compression set properties.

While the above information describes sealing members as one potential, exemplary article formed using the open-cell cellular perfluoroelastomers of the invention, it will be understood, based on this disclosure, that a wide variety of laminates, sealing members, articles, foams, filtration devices, and the like may be formed using the novel open-cell cellular perfluoroelastomers of the invention, and the disclosure herein is not intended to limit the use of such open-cell materials as fillers for sealing members.

In addition to an outer coating, in a further embodiment of the invention, an open-cell cellular perfluoroelastomer as described above may be formed which further includes closed cells dispersed throughout the matrix along with the open pores. Such closed cells may be formed using expandable microspheres and the techniques noted above for forming closed-cell perfluoroelastomers. Further, additional open and/or closed cells may be provided using controlled activation of a gas-generating agent as described above. By providing the closed cells and open cells together, unique gas transport properties in the perfluoroelastomeric matrix can be achieved. Further, such combinations provide unique materials having properties which may be optimized and/or varied by varying the ratio of open to closed cells for different applications and uses or to optimize any given application. In addition, the closed cell structure can be used to decrease costs while minimizing the number of open pores. Such a combination can be used to provide a low-cost perfluoroelastomer with a desirable number of pores for differing applications requiring more or less of an open-pore structure. An example of a sealing member 10″ as shown in the representative illustration in FIG. 3, includes both open-cells 15″ and closed-cells 14″ within a perfluoroelastomeric matrix 12″. Such a sealing member can also be formed with an optional outer coating 16″ or sheath formed in the same manner as the outer protective coatings 16, 16″ described above.

The invention further includes a method for forming an open-cell cellular perfluoroelastomer, such as those noted above, which includes combining a perfluoroelastomeric composition capable of being cured to a perfluoroelastomer with at least one curing agent and a pore forming agent(s) and/or a gas-generating agent(s) if desired in a solvent capable of dissolving the perfluoropolymer within the perfluoroelastomeric composition but incapable of dissolving the pore forming agent(s) and/or gas-generating agent(s) to form a solution. It will be understood based on this disclosure that a “solution” as used herein is preferably substantially or fully dissolved, but may also include a suspension, gel, partial gel or a dispersion. Suitable perfluoroelastomeric compositions including curing agents may be any of those specified above with respect to the closed-cell cellular perfluoroelastomer such as the peroxide curable perfluoroelastomer and others. The pore forming agent is preferably a material which is soluble in a selected solvent(s), but which is insoluble in the solvent(s) used for forming the solution of the perfluoroelastomeric composition including the curing agent(s) and pore forming agent. The preferred pore forming agents in accordance with the invention are sugars, salts such as sodium chloride, solid acids such as salicylic acid, particulate polymers such as polyvinyl chloride, as well as carbonates including sodium hydrogen carbonate, calcium carbonate and other similar compounds having similar solubility properties. Preferably the pore forming agent is a material which will also remain solid at the molding or other heat forming processing temperature for the perfluoroelastomeric composition.

Preferably, the pore forming agent is classified to provide a relatively narrow particle size distribution in order to provide uniformity to the size of the open cells formed in the cured material. If such materials are not classified in this manner initially, they may be micronized or otherwise ground using a ball mill or similar apparatus to achieve such a distribution. However, if such uniformity is not desired, it will be understood that such particle size uniformity of the pore forming material is also not necessary. In a preferred embodiment according to the invention, an open-cell cellular perfluoroelastomer is formed having an average pore size of from about 1 to about 150 microns. For use in certain applications, such pore forming agent should be available in a fine average particle size of greater than 0 and less than about 10 microns, a mid-range size of about 10 to about 50 microns in size and a larger size of greater than 50 microns. The mid-range size is a preferred range for use, for example, in cardiovascular prostheses.

The preferred solvent for use is one in which only the perfluoroelastomer composition and/or curing agent will dissolve. Most preferably only the perfluoropolymer within the perfluoroelastomeric composition will dissolve without dissolving the fillers, curing agent(s) and any other additives. The preferred solvents include specialty solvents which may may be used alone or in combination specifically designed for dissolution of perfluoroelastomers, including liquids which are themselves perfluorinated materials such as liquid perfluorinated compounds. Such solvents are known in the electronic industry. Suitable commercial perfluorinated solvents are available from 3M, St. Paul, Minn. as Fluorinert®. Preferred Fluorinert® formulations include FC-87, FC-84, FC-75 and FC-43. However, it should be understood that while such perfluorinated solvents are preferred, any known solvent, or solvent to be developed, which is capable of dissolving the perfluoropolymer within the perfluoroelastomeric composition, but not the pore forming material and/or gas-generating agents, or preferably any other curing agent(s) additives or fillers may be used within the scope of the invention.

Preferably, the total amount of solvent in the solution is about 100 parts to about 1000 parts by weight, more preferably 250 parts to about 400 parts by weight based on 100 parts by weight of perfluoropolymer(s). The curing agent or agents make up a total of about 1 part to about 10 parts by weight per 100 parts by weight perfluoropolymer, and more preferably about 1 to about 5 parts by weight. The pore forming agent should be provided in an amount of about 10 parts to about 500 parts by weight, and more preferably about 50 parts to about 200 parts by weight based on 100 parts by weight of the perfluoropolymer. High loadings of pore forming agent are preferred for forming a highly porous matrix, for example, loadings of 50 parts up to 500 parts or more pore forming agent per 100 parts of the perfluoropolymer(s) in the perfluoroelastomeric composition can provide a porosity level (density reduction) of about 85% or more. Higher levels of porosity (and lower density), if desired, may be achieved by higher loadings and may be further improved by combining the open cell cellular perfluoroelastomer material using a pore forming agent with use of a gas generating agent. Density, particle size and quantity of pore forming agent can all contribute to the ultimate characteristics of the cellular materials, for example, the density of the pore forming agent can affect porosity with respect to variations in the volume of space taken up for a given amount of pore forming agent in the matrix. The higher the density of the material, the lesser the volume of pores for the same weight of pore forming agent. Further, the particle size of the pore forming agent can be varied to modify pore size and/or pore surface area within the matrix.

Once the perfluoroelastomeric composition is in solution, and the pore forming material and curing agent are combined into the solution in dispersed form, other additives may also optionally be provided to the solution, such as those noted above with respect to the closed-cell cellular perfluoroelastomers. Such additives are preferably present in an amount of about 10 parts to about 35 parts by weight, preferably about 10 to about 25 parts by weight per 100 parts by weight of the perfluoropolymer in the perfluoroelastomeric composition.

Dissolution and/or combination of the components in the solution may be accomplished by any suitable mixing or blending technique. It is preferred that the solution is either not heated, or if heated, heated at a temperature below the curing temperature in order to avoid premature curing of the elastomer prior to thorough dispersion of the pore forming agent. Preferably, a ball mill is used to combine the solution in order to substantially or completely dissolve the perfluoropolymer within the perfluoroelastomeric composition and in order to thoroughly and uniformly disperse the pore forming agent. A ball mill, homogenizer or similar apparatus is further preferred to avoid agglomeration of the pore forming agent or other particulate additives within the combined solution. Such blending or mixing should be carried out until a sufficiently combined solution of perfluoroelastomeric composition is achieved having thoroughly dispersed curing agent and pore forming agent, and well dispersed additives, if any. Typically the consistency of the solution should be more on the order of a thick pourable liquid or a paste.

As an alternative to dissolution of the perfluoropolymers within a perfluoroelastomeric composition, it is further within the scope of the invention to use such perfluoropolymers in latex form and to combine them with a pore forming agent. Such materials may be available from perfluoropolymer manufacturers who produce perfluoropolymers using latex manufacturing processes, however, such materials can be synthesized separately, using any acceptable technique, such as those described, for example, in emulsion polymerizations such as in U.S. Pat. No. 4,281,092, incorporated herein by reference. The latex can then be easily shaped and formed on a substrate surface, for example, a shaped mandrel or similar surface. After shaping, laying or otherwise conforming the latex to the surface, the solvent within the latex can be removed by evaporation or other drying or evacuation technique leaving the shaped perfluoropolymer for curing and removal of the pore forming agent. Of course, as discussed further in connection with open-cell cellular materials below, it is further within the scope of the invention to additionally use gas generating agents and/or microspheres in the latex and activating such materials in accordance with other aspects of the invention as described herein.

After fully combining the components as discussed above, the solvent is at least partially, and preferably substantially completely removed to leave a semi-solid matrix either by evaporation, preferably using agitation or otherwise working the solution, or by the optional application of low levels of heat, such as in a drying oven, below the curing temperature of the perfluoroelastomeric composition or use of a vacuum source. Preferably, evaporation at room temperature is used in order to avoid use of heat. Once a semi-solid matrix is formed by such solvent removal step, and the matrix is cured, the pore forming material is removed from the solid matrix. This step may be accomplished by using a liquid or gaseous vehicle which is inert to the perfluoropolymer in the perfluoroelastomeric composition, but capable of reacting with, dissolving and/or ionically bonding with the pore forming material in order to remove it from the matrix. Most preferred, the pore forming material is removed from the solid matrix by washing with water or a dilute acid such as a Brønsted acid, including hydrochloric, nitric or sulfuric acid or a conventional alcohol. The solid cured matrix, which is fairly stiff becomes less stiff, and much more pliable, flexible and elastomeric in nature after removal of the pore forming agents. Preferably, the perfluoroelastomeric composition may be cured using the preferred temperature or other curing conditions for the specific perfluoroelastomeric composition and curing system. Curing may include optional post curing steps for such compositions if desired. After curing and subsequent removal of the pore forming agent, a cellular perfluoroelastomer is thus formed having a plurality of open cells. The process may also be controlled as noted above to provide open cells generated by a gas-generating agent used alone or in combination with the pore forming agent. Further, a mixed matrix may be formed by using a pore forming agent with gas-generating agents and/or microspheres and controlling the gas-generating agents, if desired, to provide varied and unique cellular combinations.

The material may be shaped, transfer molded, compression molded, extruded or the like, cured and then treated to extract the pore forming agent. Various extraction techniques may be used, provided that the pore forming material is substantially and more preferably completely removed. It will be understood that the order and particular steps for shaping the material, curing, molding and/or extracting may be varied so long as the perfluoroelastomeric composition is cured and the pore-forming agent extracted from the perfluoroelastomer matrix. The resulting open-cell cellular perfluoroelastomer has the properties and characteristics as described above with respect to the open-cell cellular composition according to the invention.

In one embodiment, after forming the solution, microspheres and/or a gas-generating agent, such as those described above with respect to the closed-cell cellular perfluoroelastomer and method of the invention, may be combined with the pore forming agent-containing solution. Microspheres and gas-generating agents may be added in amounts as noted above, and preferably from about 1 to about 20 parts per 100 parts by weight of perfluoropolymer(s) in the perfluoroelastomeric composition in the solution, and preferably from about 10 to about 15 parts. However, it will be understood, based on this disclosure, that the amount of microspheres and gas generating agents may be varied to achieve different properties in the resulting cellular perfluoroelastomer depending on the intended application and the desired porosity. In selecting the appropriate microspheres, care should be taken to ensure that the outer coating of the microsphere is not soluble in the solvent chosen for dissolving the perfluoropolymer in the perfluoroelastomeric composition. However, typically Expancel® microspheres, such as the preferred microspheres described above, are not soluble in the preferred Fluorinert® solvents. By providing microspheres and/or gas-generating agents to the solution, when curing the solid matrix and/or heating the final matrix, the microspheres may be expanded and/or the gas-generating agents activated to provide additional closed cells to the perfluoroelastomeric matrix. Such closed cells can contribute to reduction in costs in forming the perfluoroelastomeric matrix and can optimize the cellular perfluoroelastomer for various applications and also to increase porosity in a highly porous open-cell material. The microspheres may be expanded in accordance with any of the above techniques described with respect to the forming of the closed-cell cellular perfluoroelastomers and/or by using the heat energy of a molding process to expand the microspheres while curing the perfluoroelastomeric composition, and subjecting the material to a process to remove the pore forming material. The resulting mixed matrix having both open and closed cells can be used to develop sealing members having unique properties, lower material costs, good compression set characteristics as well as the ability to achieve good low temperature performance as noted above. The same technology could be used to make a closed cell structure only by omitting the pore forming agent.

When forming any of the closed-cell, open-cell or mixed open-cell and closed-cell cellular perfluoroelastomers of the invention with an outer protective coating or sheath, various techniques may be used to provide such an outer coating. A sheath may be provided by dip coating a cured, molded cellular perfluoroelastomeric article or material, for example, by dipping a rod of circular cross section for forming an O-ring in a solution of perfluoroelastomeric material and allowing the material to solidify around the core material and subsequently curing the sheath. Alternatively, such a solution of perfluoroelastomeric material may be provided as an outer coating by techniques such as coextrusion around the inner cellular core. It is also acceptable to form a tubular outer coating first such as by injection molding, extruding or similar techniques, and to provide the core cellular material in softened or liquid form to the interior of the tubular outer coating using extrusion, injection molding or other similar techniques, followed by solidification of the interior cellular material. If an interior material having expandable microspheres is used, the material may be expanded before or after enclosure within the outer coating. Expansion of the material after application of a protective coating will require estimation of the degree of expansion, which will depend on the quantity and type of microspheres used, in order not to overfill the protective coating and to ensure a tight expansion.

By using a closed-cell cellular perfluoroelastomeric outer coating, other elastomeric assemblies may be formed into more chemically resistant or plasma resistant components. In addition, the cost of providing such a coating will not significantly impact the formation of the coated item, since the quantity of overall raw material in the form of perfluoroelastomer required is reduced.

Preferably, the article may be formed by either preparing a tube of solid material and expanding the cellular material (closed or open) within the tube or preparing a cellular core composition and placing it within a tube of uncured material following by curing the entire core and surrounding sheath. Other techniques can be used and will be evident based upon the teachings in this disclosure.

The invention further includes a method for improving low temperature elastomeric properties of a perfluoroelastomeric article. The method includes forming an article which includes within the article a cellular perfluoroelastomeric material. The article may be any article formed from the perfluoroelastomeric materials of the invention as described above, including materials which are closed-cell cellular perfluoroelastomers or open-cell cellular perfluoroelastomers. Articles include any of those mentioned above as potential uses for the open-cell and closed-cell cellular materials according to the invention, however, particular benefit may be obtained in articles which are subjected to extreme temperature conditions, such as sealing members. Service temperatures of operation of lower than about −20° C., and preferably as low as about −60° C. can be achieved without significant loss in operating mechanical or sealing properties using cellular perfluoroelastomeric materials described herein. This is a significant improvement over previous perfluoroelastomeric materials which generally do not maintain acceptable properties below about −20° C.

In addition to the beneficial effects described above for improving low temperature elastomeric properties of a perfluoroelastomeric article, the present invention further provides materials which are especially useful for medical applications. The cellular perfluoroelastomeric materials of the present invention are highly useful and biocompatible when adapted for use in devices intended for contact with and/or placement in a human or animal body. Since such cellular perfluoroelastomeric materials are unique, their beneficial properties in the body are previously unknown. The cellular perfluoroelastomeric materials described herein are preferably suitable for forming devices, such as medical devices for use in a human or animal body. While not wishing to be bound by the type of medical devices which may be formed from such materials, there is a wide variety of such potential applications (including, without limitation, applications such as implants, tissue engineered products, stents, drainage tubes, pericardial patches, cannulae, catheters, fistulas, ports, prostheses and similar devices). To better illustrate such devices, two preferred devices are discussed as examples herein, a vascular prosthesis and a porous synthetic lattice or scaffold for growth of natural tissue cells. Either or both such devices may be formed from the cellular perfluoroelastomeric materials according to the invention. However, it is preferred that both the vascular prosthesis and lattice or scaffold are formed of open-cell cellular perfluoroelastomers or perfluoroelastomers having both open and closed cells.

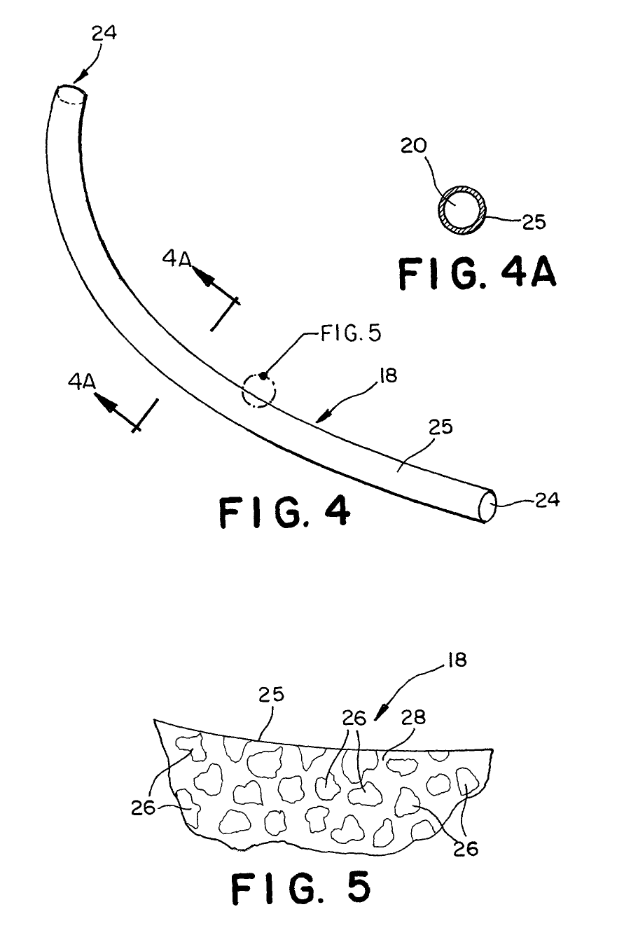

A vascular prosthesis, generally indicated as 18, according to the invention is shown in FIGS. 4 and 4A. The prosthesis 18 is shown as a tubular material having open lumen 20 extending therethrough and an opening 22 at its distal end and an opening 24 at its proximal end. The tubular material is preferably formed of a cellular perfluoroelastomeric matrix having some if not all of its cells in the form of open cells formed in accordance with the invention as described in detail above. As shown in FIG. 5, the cells within the matrix are all open cells, however, it will be understood, based on the disclosure herein that such matrix may be open cell, closed cell or a combination of open and closed cell cellular perfluoroelastomer.

In FIG. 5, the surface 25 of a portion of the prosthesis 18 is shown in a greatly enlarged view in which open cells 26 of a substantially uniform size are formed in the perfluoroelastomeric matrix 28. Such prostheses demonstrate beneficial properties since they are resistant to attack within the body, and are capable of allowing tissue ingrowth and approximating the properties of a natural vessel in terms of elastomeric properties such as flexibility and distensibility and typically have better mechanical properties such as tensile and tear strength in comparison with natural tissue. Further, the material can be easily shaped to conform to the desired size of the vessel for smooth transition between the host vessel and the prosthesis. The prostheses formed using the materials of the invention demonstrate clear benefits over prior art prostheses in that the cellular perfluoroelastomers both resist degradation and have beneficial elastomeric properties. Further, the device can closely approximate a vessel in both properties and size.

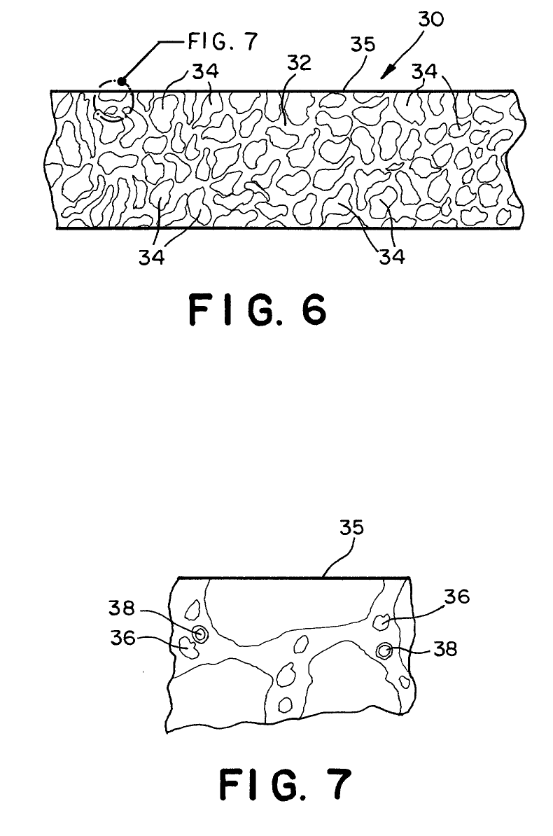

In addition, the present invention includes a device such as the synthetic lattice 30 shown in FIG. 6 for use in growing human or animal cells for making artificial or tissue engineered devices. As shown in FIG. 6, lattice 30 includes a perfluoroelastomeric matrix structural material 32 that has a large plurality of generally uniform open pores 34 throughout the lattice. The lattice, which may also be referred to herein as a scaffold, is preferably highly porous such that it is a fine framework to accommodate growth of human or animal living tissue cells. A porosity level of at least 75%, and preferably greater than about 85% or most preferably greater than about 90% is preferred for such lattice or scaffold. Such high levels of porosity may be achieved as discussed above by controlling the pore forming agent and/or the blowing agent. Further, in a preferred embodiment, as shown in FIG. 7, which is a greatly enlarged portion of the surface 35 of lattice 30 of FIG. 6, porosity may be further increased in a generally open cell structure by forming pores (open or closed) in the perfluoroelastomeric matrix. One method of further increasing porosity is to form a matrix of finely sized closed cells using microspheres, and further forming a highly porous matrix using pore forming agents. Once the structure is formed, the microspheres may be further expanded so as to break and form at least some, and preferably a majority or substantially all of the cells as open cells. As shown, relatively small particle size open cells 36 with some closed cells 38 are formed in the perfluoroelastomeric matrix 32 to provide a highly porous structure. It is desirable to avoid formation of a “skin” or fine outer coating on such a structure if maximum permeability is desired in the end product. Molding techniques may be modified for avoiding an outer “skin” or layer if desired, such as standard surface roughing techniques. Such techniques may be modified with other known molding techniques or molding techniques which may be developed for avoiding an outer “skin” or layer if desired.

In addition to the cellular devices noted herein, use of devices which include a solid perfluoroelastomer as the primary material of construction are also within the scope of the invention. Such devices may be fabricated or molded using any standard molding technique capable of shaping perfluoroelastomeric materials generally. The perfluoroelastomeric materials are highly resistant to attack and provide excellent properties for use within the body in terms of flexibility and biocompatibility.

Formation of such structures which are biocompatible and capable of withstanding long-term exposure within the body has long been desired for tissue engineering applications. The advantageous properties of the materials of the present invention provide the capability of fabricating such materials of varying matrices for different uses, and of varying degrees of porosity in the cellular embodiments, while providing excellent elastomeric and mechanical properties, long-term resistance to chemical and physical degradation and a high level of biocompatibility.

In addition to the above-described cellular perfluoroelastomers and methods discussed above, applicants also include within the scope of the invention use of all of the above cell-forming additives and methods in connection with the use of liquid forms of various fluoro- and perfluoroelastomers. Such materials are those which are already solvated or which are commercially available in liquid or paste form, thereby eliminating the need for solvent removal. Already solvated materials may be any of the above described perfluoroelastomeric materials or may include fluoroelastomeric materials of any type (FKMs in accordance with ASTM 1418-01a) which are already solvated prior to use. Non-solvated elastomers are preferred, however, in that they avoid solvent removal and may be dried by directly curing the material. One example of such a material is a terminal-silicone functional fluoroelastomer. The terminal silicone groups provide crosslinking sites. The backbone is preferably perfluorinated, however, non-perfluorinated backbones may also be used within the scope of the invention. Suitable siloxy-functional fluoroelastomers are available from Shin-Etsu as Sifel® X-71-311 and are also described in U.S. Pat. No. 5,665,846, which incorporated herein by reference.

The methods and processing techniques for this material are the same as those described above with the following exceptions. The curing system may differ from some of those mentioned above with respect to perfluoroelastomers particularly if a terminal silicone-functional crosslink is used, in which case any suitable curing system for this type of material may be used, including without limitation, a platinum based curing system.

If the elastomer is available already solvated, the method is essentially the same, however, the dissolution step may be eliminated for convenience. If the elastomer is in paste or liquid form, the dissolution step is also eliminated as is the solvent removal step. Instead, the elastomer need only be mixed with the pore forming agent, gas generating agent and/or microspheres and processed/cured accordingly without the need for additional solvent removal. This provides a significant advantage in terms of processing efficiency. However this does not exclude the option of incorporating further dissolution and/or solvent removal steps if desired.

The invention will now be further described with respect to the following non-limiting examples:

### EXAMPLE 1

A closed-cell cellular perfluoroelastomer is formed by combining 8 parts per hundred of Expancel® DU 091-81 microspheres with 100 parts of Chemraz® perfluoroelastomer gum (peroxy-curable perfluoroelastomeric terpolymer). The composition also included 5 parts per hundred N990 carbon black, 10 parts Demnum® S100, 2 parts triallyl isocyanurate (TAIC) and 2 parts Varox®, with all parts being based on 100 parts perfluoroelastomer gum (curable perfluoropolymer). All components, except Expancel® microspheres were mixed at 90° F. (32.2° C.) at 25 rpm on a Brabender mixer until homogeneous. The Expancel® microspheres were then added to the composition on a two-roll rubber mill at 150° F. until well dispersed. A preformed shape was prepared and pre-molded between sheets of release paper in a 6 in. (152.4 mm)×6 in. (152.4 mm)×0.040 in. (1.02 mm) mold and was press-set for 3 minutes at 170° F. (76.7° C.). The premolded article was loaded into a slab mold of 6 in. (152.4 mm)×6 in. (152.4 mm)×0.080 in. (2.03 mm) and cured for 10 minutes at 310° F. (154.4° C.) to form an expanded slab.

### EXAMPLE 2

A closed-cell cellular perfluoroelastomeric material is formed by combining all of the components of Example 1 under the same conditions, except that 3 parts of Celogen® OT is substituted for the 8 parts of Expancel® DU 091-81 microspheres in the formulation. The composition was loaded into a slab mold and cured under the same conditions as the cellular material in Example 1.

### EXAMPLE 3

A thin cross-section component of solid perfluoroelastomer is formed by dissolving 100 parts of Chemraz® perfluoroelastomer gum (perfluoropolymer) in 900 parts of Fluorinert blend (as described below in Example 5) along with 4 parts per hundred of triaryl cyanurate and 6 parts per hundred Lupersol® 101 in peroxide to form a perfluoroelastomer composition in solution. The components are combined in a ball mill until the perfluoroelastomer gum is dissolved. The solution is dip coated on a dissolvable mandrel and allowed to dry between dippings until the desired thickness is achieved. After complete drying, the perfluoroelastomer composition is cured on the mandrel followed by dissolving the mandrel in a solvent in which the perfluoroelastomer is insoluble.

### EXAMPLE 4

Fibers are produced using either perfluoroelastomer gum compound (perfluoropolymer) or a solution of the same by extrusion through spinnerettes. The fibers may be optionally cured and then fabricated into woven and non-woven structures to be used as non-dissolvable scaffolding for natural tissue engineering.

### EXAMPLE 5

An open-cell cellular perfluoroelastomer was formed by combining 100 g of Chemraz® perfluoroelastomer gum, 150 g of salicylic acid in powder form, 4 g of (triaryl cyanurate) TAC and 6 g of Lupersol® 101, 500 g Fluorinert® FC-75 and 400 g Fluorinert® FC-87. The components were combined by using a ball mill to combine the gum and Fluorinert® FC-75 and mixed overnight for a period sufficient to dissolve the gum in the solvent. The Fluorinert® FC-87 was then added to further dilute the liquid mixture. To this mixture, were added the TAC and Lupersol® components and the mixture was further mixed on the ball mill in a closed container. The mixture was removed from the ball mill and the salicylic acid was provided to the mixture and returned to the ball mill under conditions to properly and thoroughly combine the components. The mixture was poured out onto a plastic sheet and stirred with putty knives to create surface area and evaporate the solvent. The mixture, which was the consistency of putty, was rolled into a ball. The ball of material was then rolled on a mill slightly heated at about 80° F. (26.7° C.) until the material released from the roll indicating that it was sufficiently dry. A portion of the sheet of material formed was cut with a sharp edge into strips 12 in. (304.8 mm)×1 in. (25.4 mm) long which were formed in a mold around a rod to form a tubular shape within a mold at around 290° F. (143.3° C.) for 30 minutes. The tube was removed and immersed in ethanol overnight on the rod. The tube was removed from the rod and further washed with ethanol for an hour to ensure removal of salicylic acid and then boiled in distilled water for thirty minutes. The tube was oven dried at 120° F. (48.9° C.) and post cured at 356° F. (180° C.) for 4 hours in nitrogen.

### EXAMPLE 6

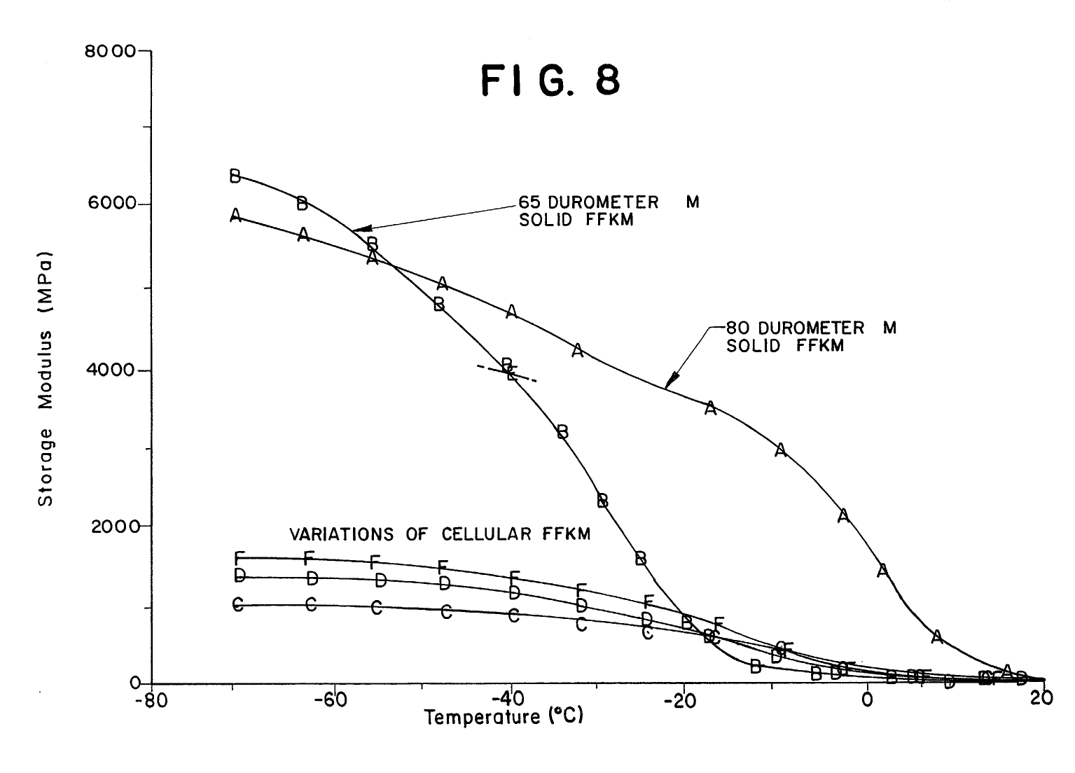

The storage modulus is a measurement which indicates relative stiffness over a range of temperatures. The measurement was made on both solid and closed cell cellular perfluoroelastomer compositions using a TA Instruments, Inc. Model DMA 2980 using a thermal ramp of 5° C./min. The storage modulus is that component of energy absorbed by a strained elastomer that is not converted to heat and is available for return to the mechanical system. The storage modulus over a range of temperatures from ambient to −60° C. was measured for each of several materials including 65 M Durometer solid FFKM (Sample B), 80 M Durometer solid FFKM (Sample A), and for two different variations of cellular perfluoroelastomer formed in accordance with the invention (Samples C and D). Sample C is a closed-cell material made in accordance with Example 1 and Sample D is a closed-cell material formed in accordance with Example 2 but using 4 parts Celogen® OT as a gas-generating agent. A graph, shown in FIG. 8 demonstrates that the cellular materials of the invention maintain elastomeric modulus down to very low temperatures which the solid FFKMs tested could not achieve. Comparisons of the flexibility of cellular FFKM and non-cellular FFKM at sub-ambient temperatures in the storage moduli shown in FIG. 8 indicates the low temperature behavior. The reduction in storage modulus correlates with satisfactory performance in field trials in which a flexing diaphragm of closed-cell perfluoroelastomer did not fail (absence of flex cracking) at −30° F. but at which solid perfluoroelastomer diaphragms failed.

### EXAMPLE 7

This Example provides analysis of arterial grafts formed using compositions according to the invention designated Samples 1-15. These sample grafts are formed in accordance with the following summary information as described further below.

Sample Nos. 1, 4 and 6—High-porosity, thick-walled tubing.

Sample Nos. 2, 3 and 5—High-porosity, thin-walled tubing.

Sample Nos. 7 and 8—Nonporous, thick-walled tubing.

Sample Nos. 9 and 10—Nonporous, thin-walled tubing.

Sample Nos. 11-15—Sheet

The samples were formed in accordance with Example 5. The high porosity, thick-walled tubular grafts (Samples 1, 4 and 6) were formed with an average wall thickness of 1 mm (average 4.5 mm ID and average 6.5 mm OD). The thin-walled, high porosity tubular grafts (Samples 2, 3 and 5) were formed of the same material but with an average wall thickness of only 0.75 mm (average 5.25 mm ID and average 6.5 mm OD). Samples 7 and 8 were formed of the same formulation without salicylic acid so that they were non-porous and of the same dimensions as the thick-walled Samples 1, 4 and 6. Samples 9 and 10 were formed of the same formulation as Samples 7 and 8, but using the same dimensions as Samples 2, 3 and 5. The sheets of Samples 11-15 were formed of the porous formulation used for Samples 2, 3 and 5 and the were made with average dimensions of 6 in. (152.4 mm) length, 6 in. (152.4 mm) width, and with a 1 mm thickness (thickness being measured in a direction transverse to the longitudinal plane of the sheets).

Testing Procedure: Three specimens of each Sample Number listed above were tested, the results, unless otherwise specified, represent an average of the three specimens tested per Sample. The Samples were subjected to the following tests:

Tensile Strength: Tensile strength tests were performed using a cross-head speed of 10 mm min⁻¹. The test method includes direct clamping of the tubular specimens between the flat faces of the test jaw in order to introduce secondary stresses, transverse to the axis of the test, at the point where the prosthesis graft Sample tube is retained in the jaw. As a result, breaking loads were expected to be recorded which were less than those which would be achieved using a different clamping construction, and failure was expected at the jaw. For the purposes of the calculation of stress and modulus, the cross-sectional area of the samples was calculated from dimensional measurements taken at the ends of the prosthesis specimens. For the sheet samples, specimens having parallel sides were produced, nominally 10 mm in width. This shape gave extension values without the use of an extensometer, but the values at break tended to be reduced. The sheet Samples were cut to examine any effects related to grain structure and were only subjected to tensile tests using specimens cut parallel with and at right angles to, the arrow showing grain direction.

Compression Testing: Compression tests were performed at a cross-head speed of 1 mm min⁻¹. Tubular specimens were tested by slitting the specimen axially along its length. Due to the curvature of the specimens, the starting point of the tests was approximated by eye, using force to flatten the specimens. The temperature at testing was 23° C. Compression testing was conducted by using a small piece of the specimen and two platens (the sections being quartered to avoid impact of the curvature of the tubular specimens). For determining acceptable compression standards (equivalent to blood pressure of about 120 mm Hg), a force equivalent to 1.5×10⁴ Pa, was used to estimate a deflection of a prosthetic tubular wall of greater than 20%.

Hoop Stress Testing: Hoop stress testing is a method of testing the radial compression characteristics and measures a complex combination of compressive and tensile behavior. Hoop stress testing was conducted using a specially constructed split rod device capable of being inserted in the tubular specimen and pulled apart at a cross-head speed of 10 mm min⁻¹. The relative levels of the two factors (tensile stress and compressive stress) depend heavily on the extension imposed on the sample and the accuracy of the fit of the test bars used for hoop stress testing into the tubing. The test bars are inserted between two test jaws for imposing force radially against the specimens. The data of hoop stress testing includes only the load measured. Deflections were calculated as a percentage of the radius of the specimen tested. The deflections are applicable along the axis of the test specimen.

Suture Pull-Out Testing: Suture pull-out testing was conducted by inserting sutures about 2 mm from the tube or sheet edge of the specimens. The sutures were withdrawn by a tensile testing machine. The cross-head speed used was 20 mm min⁻¹ at a temperature of 23° C. A steady-state load was measured while the sutures were pulled out. The sutures were positioned at approximately 90° from each other along the circumference or periphery of the specimens.

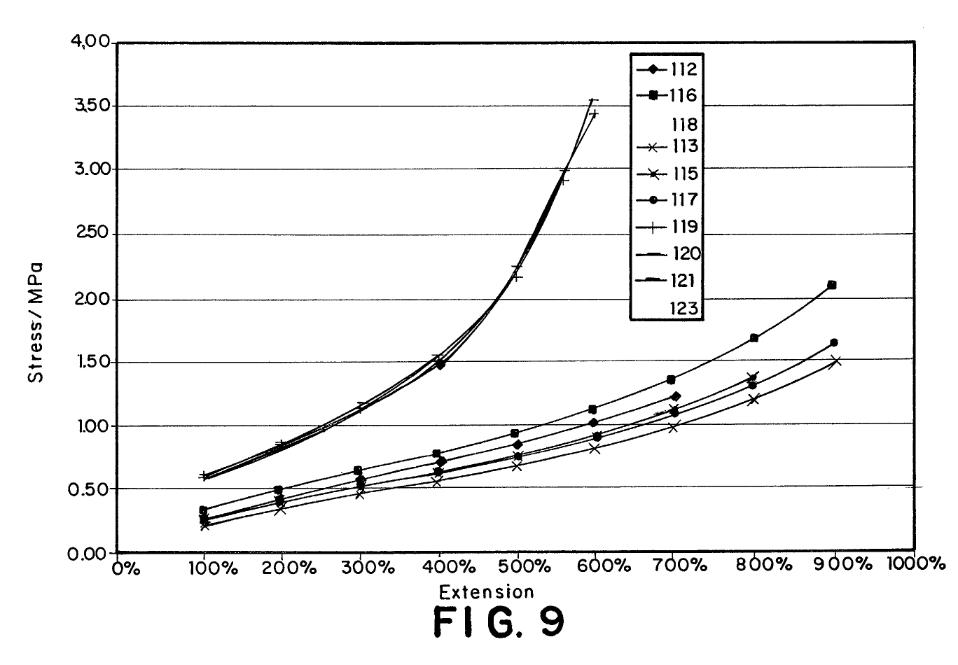

The test results for the tubular Samples (Samples 1-10) are reported first. Tensile tests are shown below in Table 1. The variation in tensile tests was broadly acceptable, considering that only 3 specimens per Sample were tested. The results show that the cellular samples were similar in behavior, with low moduli and high elongation at break. The non-cellular samples were also similar in properties, with much higher moduli and lower break strains. The data are shown graphically in FIG. 9.

TABLE 1

| | | | | | | | | | | | Extension | Stress at |
|---|---|---|---|---|---|---|---|---|---|---|---|---|
| | Stress at the given % extensions (MPa) | | | | | | | | | Modulus | at Break | Break |
| Sampl | 100% | 200% | 300% | 400% | 500% | 600% | 700% | 800% | 900% | (MPa) | (%) | (MPa) |
| 1 | 0.26 | 0.43 | 0.56 | 0.70 | 0.86 | 1.04 | 1.23* | | | 0.25 | 737 | 1.39 |
| 2 | 0.20 | 0.34 | 0.45 | 0.55 | 0.67 | 0.81 | 0.98 | 1.21 | 1.46* | 0.21 | 870 | 1.44 |
| 3 | 0.25 | 0.40 | 0.51 | 0.62 | 0.75 | 0.91 | 1.09 | 1.36 | | 0.27 | 795 | 1.35 |
| 4 | 0.31 | 0.50 | 0.64 | 0.78 | 0.94 | 1.12 | 1.36 | 1.67* | 2.09* | 0.32 | 882 | 2.00 |
| 5 | 0.26 | 0.40 | 0.50 | 0.61 | 0.72 | 0.86 | 1.04 | 1.28 | 1.65 | 0.30 | 903 | 1.64 |
| 6 | 0.28 | 0.45 | 0.58 | 0.71 | 0.85 | 1.03 | 1.26 | 1.54 | 1.77* | 0.28 | 892 | 1.88 |
| 7 | 0.57 | 0.85 | 1.14 | 1.51 | 2.17* | 3.44 | | | | 1.01 | 568 | 3.54 |
| 8 | 0.60 | 0.86 | 1.14 | 1.47 | 2.18 | 3.53 | | | | 1.20 | 617 | 3.47 |
| 9 | 0.61 | 0.88 | 1.18 | 1.56 | 2.25 | 3.50 | | | | 1.12 | 585 | 3.19 |
| 10 | 0.63 | 0.94 | 1.25 | 1.73 | 2.36* | 3.27* | | | | 1.26 | 591 | 3.32 |

% Variation

| Sample | Modulus | Ext. at Break | Stress at Break |
|---|---|---|---|
| 1 | 3.0 | 10.2 | 9.6 |
| 2 | 6.9 | 8.9 | 8.3 |
| 3 | 6.6 | 7.2 | 14.6 |
| 4 | 10.0 | 3.7 | 9.3 |
| 5 | 15.5 | 3.9 | 12.9 |
| 6 | 11.7 | 0.8 | 6.6 |
| 7 | 5.0 | 24.1 | 36.5 |
| 8 | 8.2 | 3.0 | 26.8 |
| 9 | 8.6 | 3.0 | 8.6 |
| 10 | 14.5 | 14.8 | 20.2 |

*average of two results
**single results

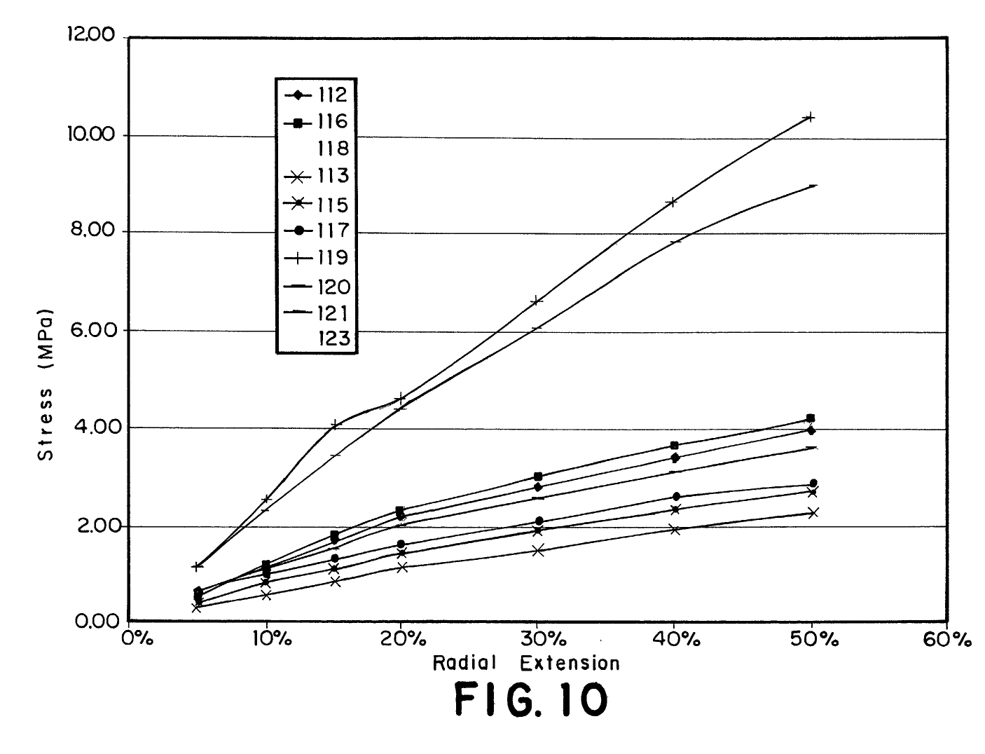

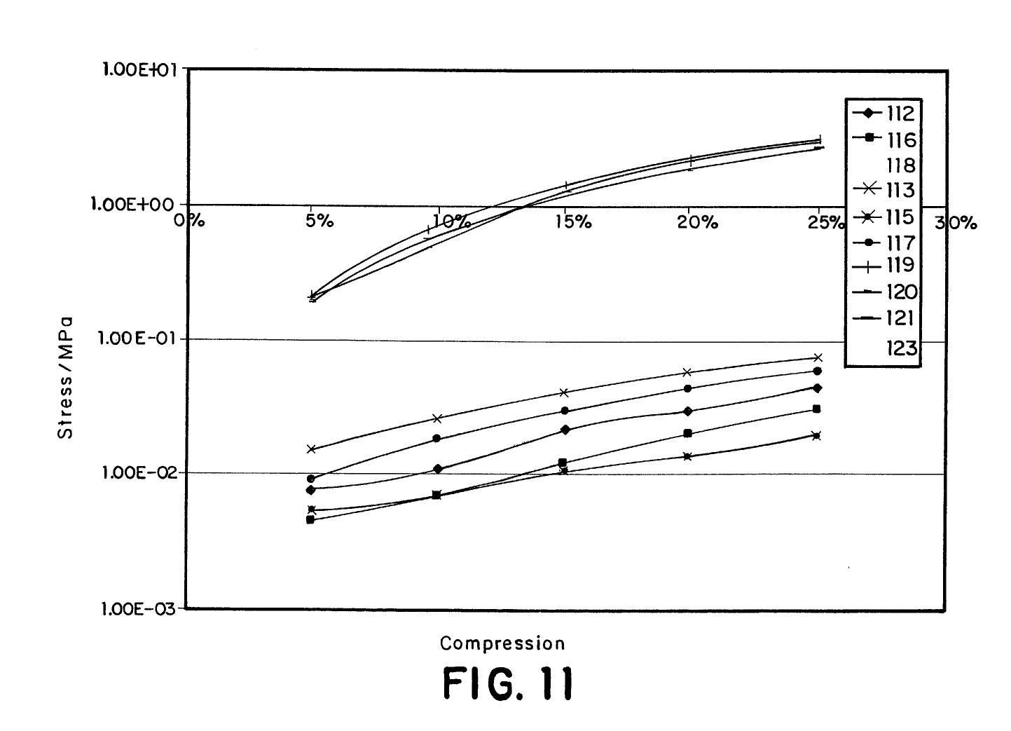

In hoop stress testing, FIG. 10 shows the predictable relationship between the relatively high strength of solid versus cellular and thick versus thin wall samples. FIG. 11 shows the large differences between cellular and non-cellular samples. It should be noted that the stress axis in FIG. 11 is logarithmic in order to allow the display of the data on one graph. The results are tabulated in Table 2. The combination of results from the tubular hoop stress and flat sheet compression tests confirm the predicted suitability of the cellular constructions for these applications.

TABLE 2

Force at Given % Radial Deflection* (N)

| Sample | 5% | 10% | 15% | 20% | 30% | 40% | 50% |
|---|---|---|---|---|---|---|---|
| 1 | 0.61 | 1.17 | 1.72 | 2.20 | 2.80 | 3.37 | 4.00 |
| 4 | 0.58 | 1.25 | 1.81 | 2.34 | 3.04 | 3.65 | 4.16 |
| 6 | 0.75 | 1.60 | 2.09 | 2.66 | 3.32 | 3.99 | 4.52 |
| 2 | 0.34 | 0.64 | 0.89 | 1.19 | 1.53 | 1.95 | 2.31 |
| 3 | 0.44 | 0.89 | 1.17 | 1.50 | 1.94 | 2.39 | 2.77 |
| 5 | 0.69 | 1.03 | 1.35 | 1.61 | 2.06 | 2.58 | 2.87 |
| 7 | 1.16 | 2.55 | 4.05 | 4.63 | 6.66 | 8.68 | 10.42 |
| 8 | 1.18 | 2.35 | 3.44 | 4.41 | 6.08 | 7.84 | 9.02 |
| 9 | 0.56 | 1.18 | 1.61 | 2.06 | 2.62 | 3.16 | 3.61 |
| 10 | 0.90 | 1.52 | 2.13 | 2.78 | 3.93 | 4.95 | 5.94 |

Variation in Compression Data at Given % Radial Deflection (± %)

| Sample | 5% | 10% | 15% | 20% | 30% | 40% | 50% |
|---|---|---|---|---|---|---|---|
| 1 | 18.95 | 20.77 | 14.84 | 7.68 | 10.11 | 7.65 | 1.71 |
| 4 | 25.38 | 33.08 | 26.43 | 25.76 | 21.69 | 19.39 | 16.64 |
| 6 | 1.79 | 3.19 | 2.81 | 3.71 | 3.48 | 2.55 | 3.13 |
| 2 | 5.78 | 12.74 | 12.29 | 8.03 | 3.81 | 7.10 | 10.61 |
| 3 | 21.53 | 15.53 | 12.07 | 11.77 | 9.41 | 7.96 | 8.17 |
| 5 | 12.20 | 3.11 | 3.74 | 1.09 | 0.23 | 1.75 | 2.62 |
| 7 | 4.19 | 6.43 | 10.31 | 4.16 | 5.41 | 6.83 | 8.25 |
| 8 | 3.18 | 3.18 | 7.46 | 6.53 | 4.74 | 3.67 | 3.19 |
| 9 | 0.96 | 1.87 | 2.77 | 3.51 | 5.03 | 6.24 | 7.41 |
| 10 | 40.34 | 31.78 | 30.35 | 33.38 | 30.61 | 33.01 | 31.99 |

*corrected to a 10 mm specimen length

As expected, in suture pull-out tests there was a general pattern of low pull-out force required for the porous (cellular) specimens and high force required for the nonporous (non-cellular) specimens. However, in absolute terms the pull-out force for the cellular samples is substantially higher than that expected for natural tissue. The results are shown in Table 3 below.

TABLE 3

| | |
|---|---|
| | Pull-Out Force/ |
| Pull-Out Force | Unit Thickness |

| Sample | (N) | Variation (%) | (N mm⁻¹) | variation (%) |
|---|---|---|---|---|
| 1 | 1.85 | 4.86 | 2.21 | 4.86 |
| 4 | 1.98 | 6.31 | 2.62 | 6.31 |
| 6 | 1.73 | 4.33 | 2.07 | 4.33 |
| 2 | 1.78 | 23.4 | 2.86 | 24.6 |
| 3 | 1.70 | 14.7 | 3.07 | 16.2 |
| 5 | 1.60 | 6.25 | 2.81 | 2.79 |
| 7 | 4.67 | 8.99 | 4.79 | 18.1 |
| 8 | 5.13 | 1.66 | 5.06 | 4.10 |
| 9 | 4.13 | 11.3 | 6.11 | 5.82 |
| 10 | 2.68 | 51.2 | 3.68 | 39.3 |

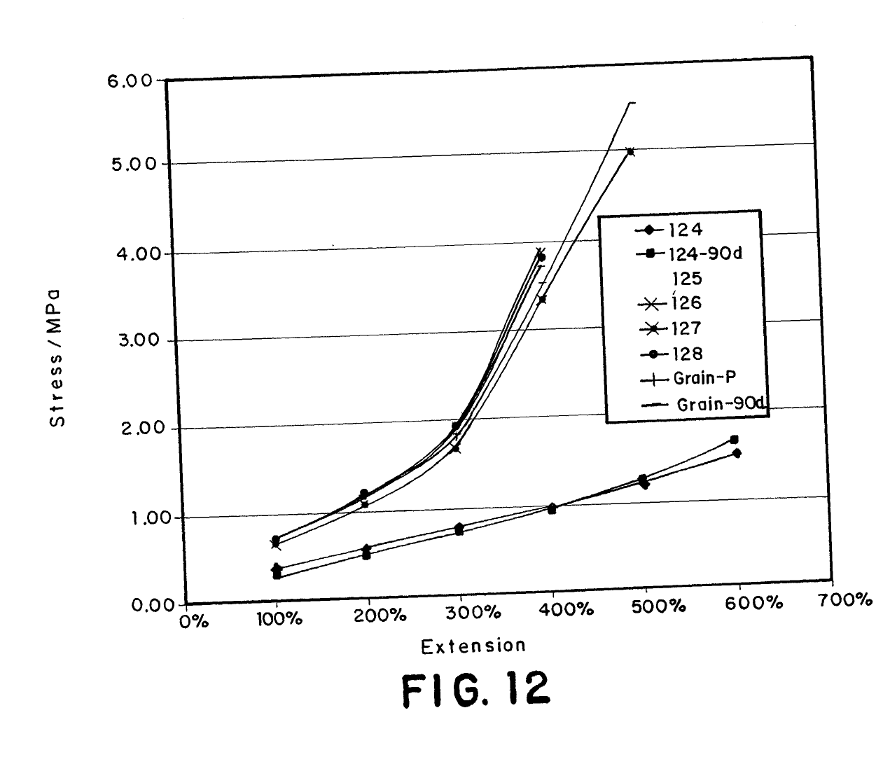

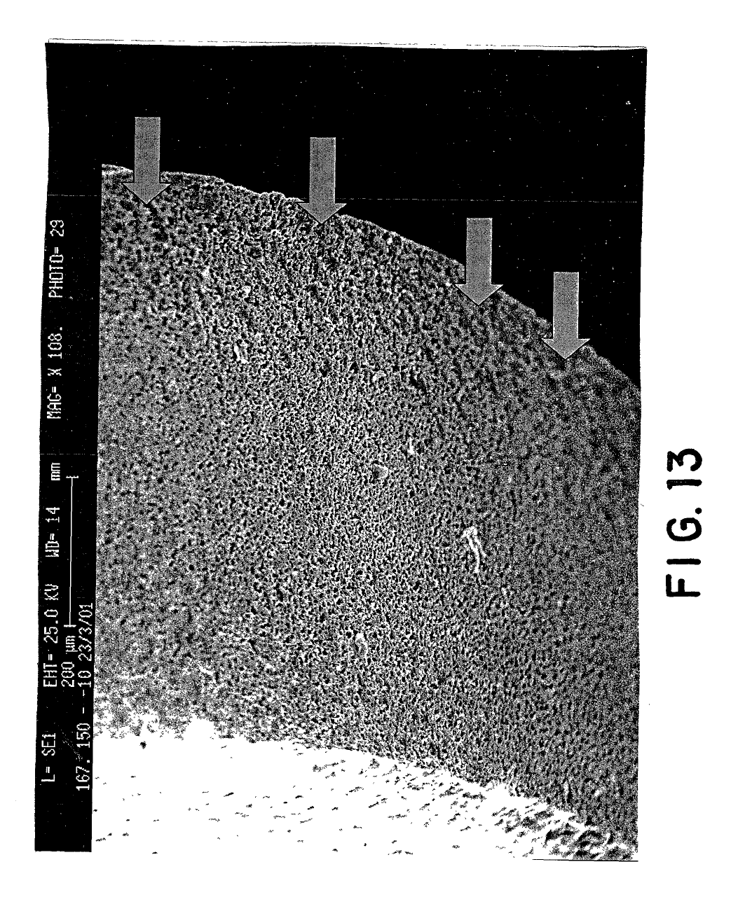

Regarding the sheet Samples tested, in the tensile tests (the results of which are shown in Table 4 and in FIG. 12) the variation appears to be broadly acceptable. The marked difference between cellular and non-cellular material is shown. The extensions at break obtained with the sheet Samples were lower than those obtained from the tubular Samples with a corresponding increase in modulus and stress at a given extension.

TABLE 4

| | | | | | | | Stress at | Extension | |
|---|---|---|---|---|---|---|---|---|---|
| | Stress at a given % extension (MPa) | | | | | | Break | at Break | Modulus |
| Sample | 100% | 200% | 300% | 400% | 500% | 600% | (MPa) | (%) | (MPa) |
| 11 | 0.36 | 0.58 | 0.77 | 0.98 | 1.21 | 1.51 | 1.55 | 601 | 0.57 |
| 11 (90° C.) | 0.29 | 0.50 | 0.73 | 0.97 | 1.26 | 1.70 | 1.98 | 647 | 0.39 |
| 12 | 0.76 | 1.20 | 1.97 | 3.89 | | | 3.76 | 397 | 1.73 |
| 13 | 0.73 | 1.16 | 1.90 | 3.90 | | | 4.22 | 413 | 1.59 |
| 14 | 0.68 | 1.07 | 1.71 | 3.38 | 4.99** | | 5.44 | 471 | 1.54 |
| 15 | 0.73 | 1.17 | 1.95 | 3.82 | | | 5.41 | 448 | 1.68 |
| Grain | 0.68 | 1.15 | 1.93 | 3.73 | | | 3.93 | 408 | 1.79 |
| Parallel | | | | | | | | | |
| Grain | 0.71 | 1.14 | 1.83 | 3.51 | 5.53 | | 4.26 | 442 | 1.59 |
| 90° C. | | | | | | | | | |

± % Variation in Results

| Sample | Stress at Break | Extension at Break | Modulus |
|---|---|---|---|
| 11 | 8.49 | 17.31 | 19.83 |
| 12 | 7.80 | 19.73 | 1.97 |
| 13 | 8.72 | 25.36 | 5.34 |
| 14 | 8.92 | 9.91 | 12.32 |
| 15 | 4.69 | 11.88 | 4.08 |
| Grain | 4.17 | 13.26 | 5.48 |
| Parallel | | | |
| Grain | 13.00 | 34.91 | 6.49 |
| 90° C. | | | |

*average of two results
**single result

### EXAMPLE 8

A scaffold for tissue engineering applications was formed using a cellular material of high porosity. The material was formed using a composition of 100 parts perfluoroelastomer gum, 2 parts (triaryl cyanurate) TAC, 3 parts Varox®, 3 parts Celogen® OT, and 10 percent by weight of FC-75 as a solvent using the same basic mixing procedure as noted above in Example 2. The material was premolded for 3 minutes at 200° F. (93.320 C.) in a 6 in. (152.4 mm)×6 in. (152.4 mm)×0.070 in. (1.78 mm) mold. The material was then allowed to expand freely while being cured at 330° F. (165.6° C.). The resulting product was a highly porous scaffold material of round 90%.

### EXAMPLE 9

The formulation of Example 5 was used to form an open celled structure cellular perfluoroelastomer using salicylic acid to demonstrate the effect of particle size on the type of open cell structure which may be formed in accordance with the invention. Sample M was formed using 150 parts of salicylic acid having an average particle size of less than about 10 microns. FIG. 13 shows that excellent distribution of cells was achieved throughout the matrix with the minor exception of the areas indicated by arrows at the surface of the material.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A closed-cell cellular perfluoroelastomeric composition, comprising:
a perfluoroelastomeric composition, comprising a curable perfluoropolymer; and
at least one material selected from the group consisting of a plurality of microspheres and a gas-generating agent.

2. The composition according to claim 1, wherein the gas-generating agent is used in an amount of about 0.1 to about 20 parts gas-generating agent per hundred parts of the perfluoropolymer.

3. The composition according to claim 1, wherein the composition comprises from about 0.1 to about 12 parts microspheres to 100 parts of the perfluoropolymer.

4. The composition according to claim 1, wherein the average particle size of the microspheres is from about 3 to about 50 microns.

5. The composition according to claim 1, wherein the microspheres comprise an outer shell comprising a copolymer of acrylic or acrylonitrile and are filled with a hydrocarbon blowing agent.

6. The composition according to claim 1, wherein the gas-generating agent has an average particle size of from about 2 to about 20 microns.

7. An article formed by a method comprising applying heat to the perfluoroelastomeric composition of claim 1 to perform at least one of expanding the microspheres and activating the gas-generating agents.

8. A closed-cell cellular perfluoroelastomer, comprising:
a perfluoroelastomeric matrix; and
a plurality of closed cells formed in the perfluoroelastomeric matrix, wherein the closed cells are formed from a material selected from the group consisting of a plurality of microspheres and a gas-generating agent.

9. The closed-cell perfluoroelastomer according to claim 8, having a density which is about 5 percent to about 95 percent of a density of a solid non-cellular perfluoroelastomer.

10. An open-cell cellular perfluoroelastomer, comprising
a perfluoroelastomeric matrix having a plurality of open pores.

11. The open-cell cellular perfluoroelastomer according to claim 10 having a density which is about 5 percent to about 95 percent of a solid perfluoroelastomer.

12. The open-cell cellular perfluoroelastomer according to claim 10, further comprising a solid perfluoroelastomeric protective coating around the perfluoroelastomeric matrix.

13. The open-cell cellular perfluoroelastomer according to claim 10, further comprising a plurality of closed cells in the perfluoroelastomeric matrix.

14. The open-cell cellular perfluoroelastomer according to claim 13, comprising about 5 percent to about 95 percent open cells and greater than 0 percent to about 90 percent closed cells.

15. The open-cell cellular perfluoroelastomer according to claim 13, further comprising a solid perfluoroelastomeric protective coating around the perfluoroelastomeric matrix.

16. The open-cell cellular perfluoroelastomer according to claim 10, further comprising a closed-cell cellular perfluoroelastomeric sheath around the perfluoroelastomeric matrix.

17. A method for making a closed-cell, cellular perfluoroelastomer, comprising:
(a) combining a perfluoroelastomeric composition with at least one material selected from the group consisting of a plurality of microspheres and a gas-generating agent at a temperature high enough to soften the perfluoroelastomeric composition but not high enough to expand the microspheres and/or activate the gas-generating agent; and
(b) further heating the perfluoroelastomeric composition and the at least one material from step (a) to cure the perfluoroelastomeric composition and to expand the microspheres and/or activate the gas-generating agent, thereby forming a cellular perfluoroelastomer having a plurality of closed cells.

18. The method according to claim 17, wherein the microspheres are expanded and/or the gas-generating agent is activated simultaneously with the curing of the perfluoroelastomeric composition.

19. The method according to claim 17, wherein the perfluoroelastomeric composition comprises a curing agent.

20. The method according to claim 17, wherein the temperature of step (a) is from about 49° C. to about 66° C.

21. The method according to claim 17, wherein the perfluoroelastomeric composition is further heated in step (b) to a temperature from about 138° C. to about 177° C.

22. A sealing member, comprising the closed-cell perfluoroelastomer formed from the method of claim 17.

23. A method for making an open-cell, cellular perfluoroelastomer, comprising:
(a) combining (i) a perfluoroelastomeric composition, comprising at least one curable perfluoropolymer and (ii) at least one of a pore forming agent and a gas-generating agent in a solvent capable of dissolving the curable perfluoropolymer but incapable of dissolving the pore forming agent or gas-generating agent to form a solution;
(b) at least partially removing the solvent from the solution to form a matrix;
(c) curing the at least one curable perfluoropolymer and removing the pore forming material from the matrix thereby forming a cellular perfluoroelastomer having a plurality of open cells.

24. The method according to claim 23, wherein the gas-generating agent is provided to the perfluoroelastomeric composition and a rate at which the gas-generating agent is activated is controlled to adjust size and number of open cells formed by the gas-generating agent in the cellular perfluoroelastomer.

25. The method according to claim 24, wherein the rate of activation of the gas-generating agent is controlled so that at least a portion of the cells formed by the gas-generating agent are partially closed or fully closed cells.

26. The method according to claim 23, wherein the solvent is a fluorosolvent.

27. The method according to claim 23, wherein the perfluoroelastomeric composition comprises at least one curing agent.

28. The method according to claim 23, wherein the pore forming agent may be removed from the matrix by extracting the pore forming agent with a solvent in which the perfluoroelastomer is insoluble.

29. The method according to claim 28, wherein the pore forming agent is selected from the group consisting of sodium chloride, solid acids, particulate polymers, sodium hydrogen carbonate, calcium carbonate, and salicylic acid.

30. The method according to claim 23, wherein the pore forming agent has an average particle size of from about 1 micron to about 150 microns prior to combining in the solution of step (a).

31. The method according to claim 23, wherein the pore forming agent is present in an amount of from about 10 parts by weight to about 500 parts by weight based on 100 parts by weight of the perfluoropolymer in the perfluoroelastomeric composition in step (a).

32. The method according to claim 23, wherein the solvent in step (a) comprises about 100 to about 1000 parts by weight per 100 parts by weight of the perfluoropolymer in the perfluoroelastomeric composition.

33. The method according to claim 23, wherein the solvent is at least partially removed in step (b) by evaporation.

34. The method according to claim 23, further comprising providing a plurality of microspheres to the solution in step (a) and subjecting the perfluoroelastomeric composition having the microspheres to heat energy to expand the microspheres.

35. The method according to claim 34, wherein the microspheres are provided in an amount of form about 1 to about 20 parts by weight per 100 parts by weight of the perfluoropolymer in the perfluoroelastomeric composition.

36. The method according to claim 23, further comprising providing a perfluoroelastomeric protective coating or a closed-cell perfluoroelastomeric protective coating around the open-cell perfluoroelastomeric composition either before or after curing the perfluoroelastomeric composition.

37. A method for improving low temperature elastomeric properties of a perfluoroelastomeric sealing member, comprising forming a sealing member which comprises a cellular perfluoroelastomeric material.

38. The method according to claim 37, wherein the cellular perfluoroelastomeric material comprises closed cells.

39. The method according to claim 37, wherein the cellular perfluoroelastomeric material comprises open cells and the material is coated with solid material.

40. A device for use in a body which comprises a perfluoroelastomeric material.

41. The device for use in a body according to claim 40, wherein the perfluoroelastomeric material is a cellular perfluoroelastomeric material.

42. The device according to claim 41, wherein the device is a vascular prosthesis.

43. The device according to claim 41, wherein the device is a porous synthetic lattice for growth of natural tissue cells on the lattice and the perfluoroelastomeric material comprises a plurality of open cells.

44. The device according to claim 41, wherein the perfluoroelastomeric material further comprises a plurality of closed cells.

45. A closed-cell cellular fluoroelastomeric composition, comprising:
a fluoroelastomer composition, comprising a curable fluoropolymer in paste or liquid form; and
at least one material selected from the group consisting of a plurality of microspheres and a gas-generating agent.

46. The closed-cell cellular fluoroelastomeric composition according to claim 45, wherein the fluoroelastomer is a perfluoroelastomer.

47. The closed-cell cellular fluoroelastomeric composition according to claim 45, wherein the fluoropolymer is terminal silicone functional.

48. An open-cell cellular fluoroelastomeric composition, comprising
a fluoroelastomeric matrix having a plurality of open pores, wherein the fluoroelastomeric matrix is derived by curing a curable fluoropolymer available in paste or liquid form.

49. The open-cell cellular fluoroelastomeric composition according to claim 48, further comprising a plurality of closed pores.

50. The open-cell cellular fluoroelastomeric composition according to claim 48, wherein the fluoroelastomer is a perfluoroelastomer.

51. The open-cell cellular fluoroelastomeric composition according to claim 48, wherein the fluoropolymer is terminal silicone functional.

52. A method for making an open-cell cellular fluoroelastomeric composition, comprising:
mixing a pore forming agent with a curable fluoroelastomer composition in liquid or paste form;
curing the fluoroelastomer and
removing the pore forming agent.

53. A method for making an open-cell, cellular perfluoroelastomer, comprising:
(a) combining (i) a perfluoroelastomeric composition in a solvent latex form, comprising at least one curable perfluoropolymer and (ii) at least one of a pore forming agent and a gas-generating agent;
(b) at least partially removing the solvent in the solvent latex from the perfluoroelastomeric composition to form a matrix; and
(c) curing the at least one curable perfluoropolymer and removing the pore forming material from the matrix thereby forming a cellular perfluoroelastomer having a plurality of open cells.

54. The method according to claim 53, wherein the method further comprises shaping the latex on a substrate surface prior to evaporating the solvent from the latex.
